(19) United States
(12) Patent Application Publication
(10) Pub. No.: US 2015/0027162 A1
(43) Pub. Date: Jan. 29, 2015

(54) COOLING SYSTEM

(71) Applicants: Yuichi Ohno, Nishio-shi (JP); Kazuhide Uchida, Hamamatsu-shi (JP); Yoshiaki Kawakami, Nagoya-shi (JP)

(72) Inventors: Yuichi Ohno, Nishio-shi (JP); Kazuhide Uchida, Hamamatsu-shi (JP); Yoshiaki Kawakami, Nagoya-shi (JP)

(73) Assignee: TOYOTA JIDOSHA KABUSHIKI KAISHA, Toyota-shi, Aichi-ken (JP)

(21) Appl. No.: 14/382,276

(22) PCT Filed: Mar. 12, 2013
(86) PCT No.: PCT/IB2013/000363

§ 371 Date: Aug. 29, 2014

(30) Foreign Application Priority Data
Mar. 16, 2012 (JP) 2012-060121

(51) Int. Cl. B60H 1/00

(52) U.S. Cl. CPC B60H 1/00271
USPC 62/525; 62/527

(57) ABSTRACT

A three-way valve switches between flow of refrigerant from a heat exchanger toward a cooling portion via a gas-liquid separator and flow of refrigerant from a heat exchanger toward the cooling portion via the gas-liquid separator. A refrigerant line provides fluid communication between the heat exchanger and the gas-liquid separator. A refrigerant line provides fluid communication between the heat exchanger and the gas-liquid separator. A selector valve switches between flow of refrigerant from the cooling portion toward the heat exchanger via a refrigerant line and flow of refrigerant from the cooling portion toward the heat exchanger via a refrigerant line.

### BACKGROUND OF THE INVENTION

1. Field of the Invention

The invention relates to a cooling system and, more particularly, to a cooling system that cools a heat generating source by utilizing a vapor compression refrigeration cycle.

2. Description of Related Art

As for an existing vehicle air-conditioning system, for example, Japanese Patent Application Publication No. 5-96940 (JP 5-96940 A) describes an air-conditioning system that includes an interior air heat exchanger and that is able to carry out heating mode operation and cooling mode operation with the use of a four-way valve.

In recent years, hybrid vehicles, fuel cell vehicles, electric vehicles, and the like, that run with driving force of a motor become a focus of attention as one of measures against environmental issues. In such vehicles, electrical devices, such as a motor, a generator, an inverter, a converter and a battery, exchange electric power to generate heat. Therefore, these electrical devices need to be cooled. Then, there is suggested a technique for cooling a heat generator by utilizing a vapor compression refrigeration cycle that is used as a vehicle air-conditioning system.

For example, Japanese Patent Application Publication No. 2005-90862 (JP 2005-90862 A) describes a cooling system in which heat generator cooling means for cooling a heat generator is provided in a bypass passage that bypasses a decompressor, an evaporator and a compressor of an air-conditioning refrigeration cycle. Japanese Patent Application Publication No. 2007-69733 (JP 2007-69733 A) describes a system in which a heat exchanger that exchanges heat with air-conditioning air and a heat exchanger that exchanges heat with a heat generator are arranged in parallel in a refrigerant line from an expansion valve to a compressor and then the heat generator is cooled by utilizing refrigerant for an air-conditioning system.

Japanese Patent Application Publication No. 2000-198347 (JP 2000-198347 A) describes a heat pump air-conditioning system that improves heating performance by recovering waste heat from a motor with the use of coolant and then transferring heat from coolant to refrigerant. Japanese Patent Application Publication No. 9-290622 (JP 9-290622 A) describes a technique for effectively improving heating performance at the time of a low outside air temperature while suppressing an increase in electric power consumption by recovering waste heat from a heat generating portion mounted on a vehicle and then causing refrigerant for gas injection to absorb heat.

In the cooling system described in JP 2005-90862 A, it is required to operate the compressor in order to circulate refrigerant in the vapor compression refrigeration cycle and, in addition, it is required to constantly drive a pump in order to cool a heat generator by supplying refrigerant to the heat generator. Therefore, there is a problem that a fuel consumption and/or an electric power consumption deteriorate.

### SUMMARY OF THE INVENTION

The invention provides a cooling system that is able, to efficiently cool a heat generating source at a lower power during both cooling and heating.

An aspect of the invention provides a cooling system that cools a heat generating source. The cooling system includes: a compressor that is configured to compress refrigerant; a first heat exchanger and a second heat exchanger that are configured to exchange heat between the refrigerant and outside air; a first decompressor that is configured to decompress the refrigerant; a third heat exchanger that is configured to exchange heat between the refrigerant and air-conditioning air; a reservoir that is configured to store the refrigerant in a liquid phase, condensed in the first heat exchanger or the second heat exchanger; and a cooling portion that is configured to cool the heat generating source using the refrigerant in a liquid phase. The cooling system further includes a first selector valve. The first selector valve is configured to switch between flow of the refrigerant from the first heat exchanger toward the cooling portion via the reservoir and flow of the refrigerant from the second heat exchanger toward the cooling portion via the reservoir. The cooling system further includes: a first line that provides fluid communication between the first heat exchanger and the reservoir; a second line that provides fluid communication between the second heat exchanger and the reservoir; a third line through which the refrigerant in a liquid phase flows from the reservoir toward the cooling portion; a first flow regulating valve that is provided in the first line and that is configured to adjust a flow rate of the refrigerant flowing through the cooling portion; and a second flow regulating valve that is provided in the second line and that is configured to adjust the flow rate of the refrigerant flowing through the cooling portion. The cooling system further includes: a fourth line; a fifth line; and a second selector valve. The fourth line provides fluid communication between an outlet side of the cooling portion and the first line between the first heat exchanger and the first flow regulating valve. The fifth line provides fluid communication between the outlet side of the cooling portion and the second line between the second heat exchanger and the second flow regulating valve. The second selector valve is configured to switch between flow of the refrigerant from the cooling portion toward the first heat exchanger via the fourth line and flow of the refrigerant from the cooling portion toward the second heat exchanger via the fifth line.

The cooling system may include: a sixth line; a communication line; and an on-off valve. The sixth line constitutes a path of the refrigerant flowing into or flowing out from the first heat exchanger together with the first line. The communication line provides fluid communication between the outlet side of the cooling portion and the sixth line. The on-off valve is configured to open or close the communication line.

In the cooling system, the heat generating source may be arranged below the first heat exchanger.

In the cooling system, the first heat exchanger may have a higher heat radiation performance for releasing heat from the refrigerant than the second heat exchanger.

The cooling system may further include an interior condenser that is arranged on a downstream side of flow of air-conditioning air with respect to the third heat exchanger and that is configured to transfer heat from the refrigerant compressed in the compressor to the air-conditioning air to thereby heat the air-conditioning air.

The cooling system may further include a second decompressor that is provided in a path of the refrigerant flowing from the compressor to the second heat exchanger via the first selector valve and that is configured to decompress the refrigerant; and a branching line that is configured to branch part of the refrigerant decompressed in the second decompressor and to flow the part of the refrigerant to the third heat exchanger.

With the above-described cooling system, it is possible to efficiently cool the heat generating source at a low power during both cooling operation and heating operation.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that shows the configuration of a cooling system according to an embodiment that is one example of the invention;

FIGS. 2A and 2B are views that show settings of a compressor and valves in each operation mode of the cooling system according to the embodiment;

FIG. 3 is a Mollier chart that shows the state of refrigerant in a vapor compression refrigeration cycle in a first operation mode of the cooling system according to the embodiment;

FIG. 4 is a schematic view that shows the operation of the cooling system in a second operation mode of the cooling system according to the embodiment;

FIG. 5 is a Mollier chart that shows the state of refrigerant in the vapor compression refrigeration cycle in the second operation mode;

FIG. 6 is a schematic view, that shows the operation of the cooling system in a third operation mode of the cooling system according to the embodiment;

FIG. 7 is a Mollier chart that shows the state of refrigerant in the vapor compression refrigeration cycle in the third operation mode;

FIG. 8 is a schematic view that shows the operation of the cooling system in a fourth operation mode of the cooling system according to the embodiment;

FIG. 9 is a schematic view that shows the configuration of part of the cooling system shown in FIG. 8;

FIG. 10 is a Mollier chart that shows the state of refrigerant in the vapor compression refrigeration cycle in the fourth operation mode; and

FIG. 11 is a schematic view that shows the operation of the cooling system in a fifth operation mode of the cooling system according to the embodiment.

### DETAILED DESCRIPTION OF EMBODIMENTS

Hereinafter, an embodiment of the invention will be described with reference to the accompanying drawings. Note that like reference numerals denote the same or corresponding portions in the drawings and the description thereof is not repeated.

### Configuration of Cooling System 1

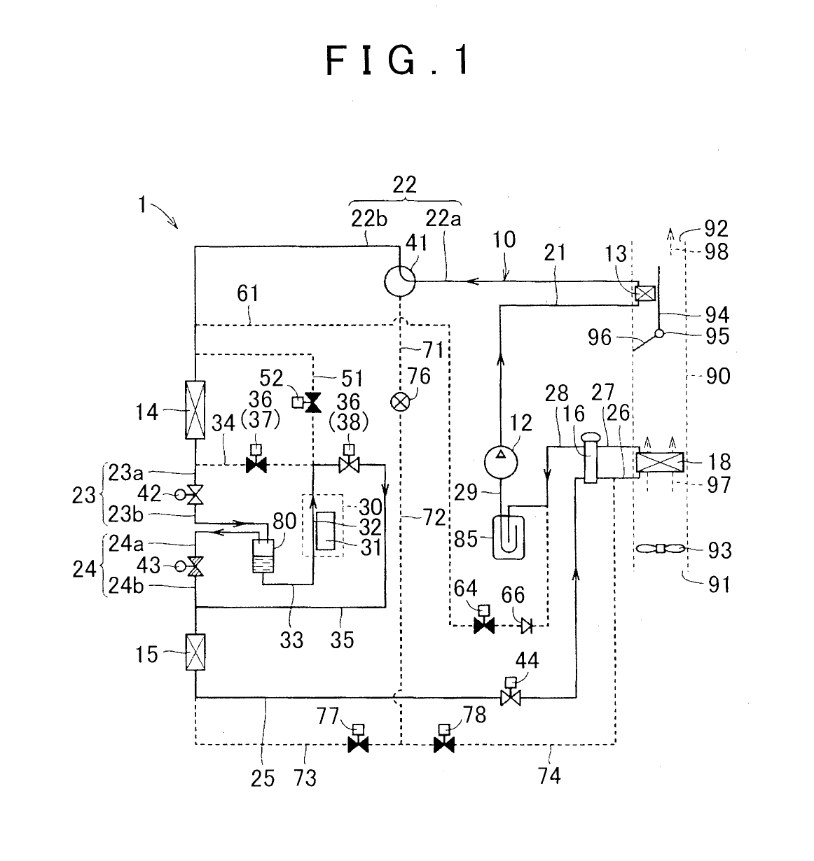

FIG. 1 is a schematic view that shows the configuration of a cooling system 1. As shown in FIG. 1, the cooling system 1 includes a vapor compression refrigeration cycle 10. The vapor compression refrigeration cycle 10 is, for example, mounted on a vehicle in order to cool or heat the cabin of the vehicle. Cooling using the vapor compression refrigeration cycle 10 is performed, for example, when a switch for cooling is turned on or when an automatic control mode in which the temperature in the cabin of the vehicle is automatically adjusted to a set temperature is selected and the temperature in the cabin is higher than the set temperature. Heating using the vapor compression refrigeration cycle 10 is performed, for example, when a switch for heating is turned on or when the automatic control mode is selected and the temperature in the cabin is lower than the set temperature.

The vapor compression refrigeration cycle 10 includes a compressor 12, a heat exchanger 14 that serves as a first heat exchanger, a heat exchanger 15 that serves as a second heat exchanger, an expansion valve 16 that is an example of a decompressor, a heat exchanger 18 that serves as a third heat exchanger, and a heat exchanger 13 that serves as an interior condenser.

The compressor 12 is actuated by a motor or engine equipped for the vehicle as a power source, and adiabatically compresses refrigerant gas to obtain superheated refrigerant gas. The compressor 12 introduces and compresses gaseous refrigerant flowing during operation of the vapor compression refrigeration cycle 10, and discharges high-temperature and high-pressure gaseous refrigerant. The compressor 12 discharges refrigerant to the refrigerant line 21 to thereby circulate refrigerant in the vapor compression refrigeration cycle 10.

Each of the heat exchangers 14 and 15 includes tubes and fins. The tubes flow refrigerant. The fins are used to exchange heat between refrigerant flowing through the tubes and air around the heat exchanger 14 or 15. The heat exchangers 14 and 15 exchange heat between refrigerant and outside air, and cause superheated refrigerant gas, compressed in the compressor 12, to release heat to an external medium with a constant pressure and to become refrigerant liquid. Owing to heat exchange between cooling air and refrigerant in the heat exchangers 14 and 15, the temperature of refrigerant decreases, and refrigerant liquefies. Outside air may be supplied to the heat exchangers 14 and 15 by natural draft that is generated as the vehicle runs. Alternatively, outside air may be supplied to the heat exchangers 14 and 15 by forced draft from a cooling fan (not shown), such as a condenser fan and an engine cooling radiator fan.

The expansion valve 16 causes high-pressure liquid refrigerant to be sprayed through a small hole to expand into low-temperature and low-pressure atomized refrigerant. The expansion valve 16 decompresses condensed refrigerant liquid into wet steam in a gas-liquid mixing state. Note that a decompressor for decompressing refrigerant liquid is not limited to the expansion valve 16 that carries out throttle expansion; instead, the decompressor may be a capillary tube.

The expansion valve 16 may be a thermal expansion valve of which the valve opening degree is determined by a balance between a pressure difference between refrigerant at an outlet of the expansion valve 16 and refrigerant at an outlet of the heat exchanger 18 and a spring force. The valve opening degree of the thermal expansion valve is controlled such that a degree of superheat of refrigerant at the outlet of the heat exchanger 18 is constant. For example, when a degree of superheat of refrigerant at the outlet of the heat exchanger 18 is high, the pressure difference in refrigerant increases. In this case, the valve opening degree increases to increase the flow rate of refrigerant. By so doing, it is possible to reduce a degree of superheat of refrigerant. Conversely, when a degree of superheat of refrigerant at the outlet of the heat exchanger 18 is low, the valve opening degree reduces to reduce the flow rate of refrigerant. By so doing, it is possible to increase a degree of superheat of refrigerant. The expansion valve 16 is not limited to a thermal expansion valve. An electric expansion valve may be employed as the expansion valve 16.

Each of the heat exchangers 13 and 18 includes tubes and fins. The tubes flow refrigerant. The fins are used to exchange heat between refrigerant flowing through the tubes and air around the heat exchanger 13 or 18. The heat exchangers 13 and 18 exchange heat between refrigerant and air-conditioning air flowing through the duct 90 The temperature of air-conditioning air is adjusted by heat exchange between refrigerant that circulates in the vapor compression refrigeration cycle 10 via the heat exchangers 13 and 18 and air-conditioning air. Air-conditioning air may be outside air or may be air in the cabin of the vehicle.

The vapor compression refrigeration cycle 10 includes an accumulator 85 that is provided in a path of refrigerant on the upstream side of the compressor 12. The accumulator 85 is provided in order to keep the state of refrigerant, which is introduced into the compressor 12, constant. The accumulator 85 has the function of, when refrigerant flowing into the accumulator 85 is in a gas-liquid two-phase state, separating refrigerant into gas and liquid, storing refrigerant liquid in the accumulator 85 and returning gaseous refrigerant in a saturated steam state to the compressor 12. The accumulator 85 introduces only gaseous refrigerant steam into the compressor 12, and serves to prevent refrigerant liquid from flowing into the compressor 12.

The vapor compression refrigeration cycle 10 further includes refrigerant lines 21 to 29. The refrigerant line 21 provides fluid communication between the compressor 12 and the heat exchanger 13. Refrigerant flows from the compressor 12 toward the heat exchanger 13 between the compressor 12 and the heat exchanger 13 via the refrigerant line 21. The refrigerant line 22 provides fluid communication between the heat exchanger 13 and the heat exchanger 14. Refrigerant flows from the heat exchanger 13 toward the heat exchanger 14 between the heat exchanger 13 and the heat exchanger 14 via the refrigerant line 22. The refrigerant lines 23 and 24 provide fluid communication between the heat exchanger 14 and the heat exchanger 15. Refrigerant flows from one of the heat exchanger 14 and the heat exchanger 15 toward the other between the heat exchanger 14 and the heat exchanger 15 via the refrigerant lines 23 and 24.

The refrigerant line 25 provides fluid communication between the heat exchanger 15 and the expansion valve 16. Refrigerant flows from the heat exchanger 15 toward the expansion valve 16 between the heat exchanger 15 and the expansion valve 16 via the refrigerant line 25. An on-off, valve 44 that is able to open or close the refrigerant line 25 is provided in the refrigerant line 25. The on-off valve 44 switches between the open state and the closed state to thereby switch between fluid communication and interruption of the refrigerant line 25. By so doing, the on-off valve 44 allows or prohibits flow of refrigerant through the refrigerant line 25.

The refrigerant line 26 provides fluid communication between the expansion valve 16 and the heat exchanger 18. Refrigerant flows from the expansion valve 16 toward the heat exchanger 18 between the expansion valve 16 and the heat exchanger 18 via the refrigerant line 26. The refrigerant line 27 provides fluid communication between the heat exchanger 18 and the expansion valve 16. Refrigerant flows from the heat exchanger 18 toward the expansion valve 16 between the heat exchanger 18 and the expansion valve 16 via the refrigerant line 27.

The refrigerant line 28 provides fluid communication between the expansion valve 16 and the accumulator 85. Refrigerant flows from the expansion valve 16 toward the accumulator 85 between the expansion valve 16 and the accumulator 85 via the refrigerant line 28. The refrigerant line 29 provides fluid communication between the accumulator 85 and the compressor 12. Refrigerant flows from the accumulator 85 toward the compressor 12 between the heat exchanger 18 and the compressor 12 via the refrigerant line 29.

The vapor compression refrigeration cycle 10 is formed such that the compressor 12, the heat exchangers 13, 14, 15, the expansion valve 16 and the heat exchanger 18 are coupled by the refrigerant lines 21 to 29. Note that refrigerant used in the vapor compression refrigeration cycle 10 may be, for example, carbon dioxide, hydrocarbon, such as propane and isobutane, ammonia, chlorofluorocarbons, water, or the like.

The vapor compression refrigeration cycle 10 further includes a gas-liquid separator 80. The gas-liquid separator 80 is arranged in a path of refrigerant between the heat exchanger 14 and the heat exchanger 15. The gas-liquid separator 80 separates refrigerant flowing into the gas-liquid separator 80 into gaseous refrigerant and liquid refrigerant. Refrigerant liquid that is liquid refrigerant and refrigerant steam that is gaseous refrigerant are stored inside the gas-liquid separator 80. The refrigerant lines 23 and 24 and a refrigerant line 33 (described later) are coupled to the gas-liquid separator 80.

Refrigerant condensed in the heat exchanger 14 is in a wet steam gas-liquid two-phase state, mixedly containing saturated liquid and saturated steam. Refrigerant flowing out from the heat exchanger 14 is supplied to the gas-liquid separator 80 through the refrigerant line 23. Refrigerant flowing from the refrigerant line 23 into the gas-liquid separator 80 is separated into gas and liquid inside the gas-liquid separator 80. The gas-liquid separator 80 separates refrigerant into liquid-state refrigerant liquid and gaseous refrigerant steam and temporarily stores them. The gas-liquid separator 80 has the function of a reservoir that temporarily stores refrigerant liquid that is liquid refrigerant inside. Thus, the gas-liquid separator 80 is also referred to as the reservoir 80.

The path of refrigerant that flows between the heat exchanger 14 and the heat exchanger 15 includes the refrigerant line 23 and the refrigerant line 24. The refrigerant line 23 serves as a first line that provides fluid communication between the heat exchanger 14 and the gas-liquid separator 80. The refrigerant line 24 serves as a second line that provides fluid communication between the gas-liquid separator 80 and the heat exchanger 15. A flow regulating valve 42 that serves as a first flow regulating valve is provided in the refrigerant line 23. The refrigerant line 23 includes a refrigerant line 23a and a refrigerant line 23b. The refrigerant line 23a provides fluid communication between the heat exchanger 14 and the flow regulating valve 42. The refrigerant line 23b provides fluid communication between the flow regulating valve 42 and the gas-liquid separator 80. A flow regulating valve 43 that serves as a second flow regulating valve is provided in the refrigerant line 24. The refrigerant line 24 includes a refrigerant line 24a and a refrigerant line 24b. The refrigerant line 24a provides fluid communication between the gas-liquid separator 80 and the flow regulating valve 43. The refrigerant line 24b provides fluid communication between the flow regulating valve 43 and the heat exchanger 15.

The path of refrigerant flowing between the heat exchanger 14 and the heat exchanger 15 further includes the refrigerant line 33 that serves as a third line, a refrigerant line 34 that serves as a fourth line, and a refrigerant line 35 that serves as a fifth line. The refrigerant line 33 provides fluid communication between the gas-liquid separator 80 and the inlet side of a cooling portion 30. The refrigerant line 34 provides fluid communication between the outlet side of the cooling portion 30 and the refrigerant line 23a. The refrigerant line 35 provides fluid communication between the outlet side of the cooling portion 30 and the refrigerant line 24b. The cooling portion 30 is provided in the path of refrigerant flowing between the heat exchanger 14 and the heat exchanger 15. Liquid refrigerant flows from the gas-liquid separator 80 toward the cooling portion 30 via the refrigerant line 33. Refrigerant passing through the cooling portion 30 returns to the refrigerant line 24b via the refrigerant line 35 or returns to the refrigerant line 23a via the refrigerant line 34.

Refrigerant liquid separated by the gas-liquid separator 80 flows out to the outside of the gas-liquid separator 80 via the refrigerant line 33. The end portion of the refrigerant line 33 is connected to a refrigerant liquid storage portion in which liquid refrigerant is stored inside the gas-liquid separator 80, and forms an outlet port through which liquid refrigerant flows out from the gas-liquid separator 80. Refrigerant steam separated by the gas-liquid separator 80 flows out to the outside of the gas-liquid separator 80 via the refrigerant line 23 or the refrigerant line 24. The end portions of the refrigerant lines 23 and 24 are connected to a refrigerant steam storage portion in which gaseous refrigerant is stored in the gas-liquid separator 80. One of the end portions forms an inlet port through which refrigerant flows into the gas-liquid separator 80, and the other one of the end portions forms an outlet port through which gaseous refrigerant flows out from the gas-liquid separator 80. The refrigerant lines 23 and 24 form lines through which gaseous refrigerant separated in the gas-liquid separator 80 flows out from the gas-liquid separator 80.

Inside the gas-liquid separator 80, the refrigerant liquid accumulates at the lower side and the refrigerant steam accumulates at the upper side. The end portions of the refrigerant lines 23 and 24 are coupled to the ceiling portion of the gas-liquid separator 80. The end portion of the refrigerant line 33 is coupled to the bottom portion of the gas-liquid separator 80. Refrigerant in a gas-liquid two-phase state is supplied to the inside of the gas-liquid separator 80 via any one of the refrigerant lines 23 and 24, only refrigerant steam is delivered to the outside of the gas-liquid separator 80 from the ceiling side of the gas-liquid separator 80 via the other one of the refrigerant lines 23 and 24, and only refrigerant liquid is delivered to the outside of the gas-liquid separator 80 from the bottom side of the gas-liquid separator 80 via the refrigerant line 33. By so doing, the gas-liquid separator 80 is able to reliably separate gaseous refrigerant and liquid refrigerant from each other.

The cooling system 1 includes two refrigerant paths connected in parallel between the heat exchangers 14 and 15. More specifically, the cooling system 1 includes two refrigerant paths connected in parallel between the heat exchanger 14 and the gas-liquid separator 80 and two refrigerant paths connected in parallel between the heat exchanger 15 and the gas-liquid separator 80.

The cooling portion 30 is provided in one of the plurality of refrigerant paths connected in parallel between the heat exchanger 14 and the heat exchanger 15. The cooling portion 30 includes an electric vehicle (EV) device 31 and a cooling line 32. The EV device 31 is an electrical device mounted on the vehicle. The cooling line 32 is a line through which refrigerant flows. The EV device 31 is an example of a heat generating source. The inlet-side end portion of the cooling line 32 is connected to the refrigerant line 33. The outlet-side end portion of the cooling line 32 is in fluid communication with the refrigerant lines 34 and 35.

The refrigerant line 23 constitutes one of the refrigerant paths connected in parallel between the heat exchanger 14 and the gas-liquid separator 80. The refrigerant line 33 that provides fluid communication between the gas-liquid separator 80 and the cooling portion 30, the cooling line 32 that is included in the cooling portion 30 and the refrigerant line 34 that provides fluid communication between the outlet side of the cooling portion 30 and the refrigerant line 23a constitute the other one of the refrigerant paths connected in parallel between the heat exchanger 14 and the gas-liquid separator 80. The refrigerant line 33 is a refrigerant path on the upstream side of the cooling portion 30, and refrigerant flows into the cooling portion 30 via the refrigerant line 33. The refrigerant line 33 is a line through which liquid refrigerant flows from the gas-liquid separator 80 to the cooling portion 30. The refrigerant line 34 is a refrigerant path on the downstream side of the cooling portion 30, and refrigerant flows out from the cooling portion 30 and flows into the refrigerant line 34. The refrigerant line 34 is a line through which refrigerant is returned from the cooling portion 30 to the refrigerant line 23.

The refrigerant line 24 constitutes one of the refrigerant paths connected in parallel between the heat exchanger 15 and the gas-liquid separator 80. The refrigerant line 33 that provides fluid communication between the gas-liquid separator 80 and the cooling portion 30, the cooling line 32 that is included in the cooling portion 30 and the refrigerant line 35 that provides fluid communication between the outlet side of the cooling portion 30 and the refrigerant line 24b constitute the other one of the refrigerant paths connected in parallel between the heat exchanger 15 and the gas-liquid separator 80. The refrigerant line 35 is a refrigerant path on the downstream side of the cooling portion 30, and refrigerant flows out from the cooling portion 30 and flows into the refrigerant line 35. The refrigerant line 35 is a line through which refrigerant is returned from the cooling portion 30 to the refrigerant line 24.

Refrigerant liquid flowing out from the gas-liquid separator 80 flows toward the cooling portion 30 via the refrigerant line 33. Refrigerant that flows to the cooling portion 30 and that flows via the cooling line 32 takes heat from the EV device 31, which serves as the heat generating source, to cool the EV device 31 in accordance with a temperature difference between the EV device 31, which serves as the heat generating source, and refrigerant. The cooling portion 30 uses refrigerant in a saturated liquid state, separated in the gas-liquid separator 80, to cool the EV device 31. Refrigerant flowing through the cooling line 32 exchanges heat with the EV device 31 in the cooling portion 30 to cool the EV device 31, and the refrigerant is heated.

Refrigerant liquid in a saturated liquid state is stored inside the gas-liquid separator 80. The gas-liquid separator 80 functions as a reservoir that temporarily stores refrigerant liquid that is liquid refrigerant inside. When refrigerant liquid in a predetermined amount is stored in the gas-liquid separator 80, the flow rate of refrigerant flowing from the gas-liquid separator 80 to the cooling portion 30 may be maintained at the time of fluctuations in load. Because the gas-liquid separator 80 has the function of storing liquid, serves as a buffer against load fluctuations and is able to absorb load fluctuations, the cooling performance for cooling the EV device 31 may be stabilized.

The cooling portion 30 is configured to be able to exchange heat between the EV device 31 and refrigerant in the cooling line 32. In the present embodiment, the cooling portion 30, for example, has the cooling line 32 that is formed such that the outer periphery of the cooling line 32 is in direct contact with the casing of the EV device 31. The cooling line 32 has a portion adjacent to the casing of the EV device 31. At that portion, heat is exchangeable between refrigerant, flowing through the cooling line 32, and the EV device 31.

The EV device 31 is directly connected to the outer periphery of the cooling line 32 that forms part of the refrigerant path between the heat exchanger 14 and the heat exchanger 15 in the vapor compression refrigeration cycle 10, and is cooled. Refrigerant and the EV device 31 may directly exchange heat with each other or refrigerant and secondary medium, such as water or oil flowing through the EV device 31, may exchange heat with each other. The EV device 31 is arranged on the outside of the cooling line 32, so the EV device 31 does not interfere with flow of refrigerant flowing inside the cooling line 32. Therefore, the pressure loss of the vapor compression refrigeration cycle 10 does not increase, so the EV device 31 may be cooled without increasing the power of the compressor 12.

Alternatively, the cooling portion 30 may include a selected known heat transfer device that is interposed between the EV device 31 and the cooling line 32. In this case, the EV device 31 is connected to the outer periphery of the cooling line 32 via the heat transfer device, and heat is transferred from the EV device 31 to the cooling line 32 via the heat transfer device to thereby cool the EV device 31. For example, a Wick heating pipe may be used as the heat transfer device. The EV device 31 serves as a heating portion for heating the heat pipe, and the cooling line 32 serves as a cooling portion for cooling the heat pipe to thereby increase the heat-transfer efficiency between the cooling line 32 and the EV device 31, so it is possible to improve the cooling efficiency of the EV device 31.

The heat transfer device is able to reliably transfer heat from the EV device 31 to the cooling line 32, so there may be a distance between the EV device 31 and the cooling line 32, and complex arrangement of the cooling line 32 is not required to bring the cooling line 32 into contact with the EV device 31. As a result, arrangement of the EV device 31 is not restricted, and it is possible to improve the flexibility of arrangement of the EV device 31.

The EV device 31 includes an electrical device that exchanges electric power to generate heat. The electrical device includes at least any one of, for example, an inverter used to convert direct-current power to alternating-current power, a motor generator that is a rotating electrical machine, a battery that is an electrical storage device, a step-up converter that is used to step up the voltage of the battery and a DC/DC converter that is used to step down the voltage of the battery. The battery is a secondary battery, such as a lithium ion battery and a nickel metal hydride battery. A capacitor may be used instead of the battery.

An on-off valve 37 that is able to open or close the refrigerant line 34 is provided in the refrigerant line 34. The on-off valve 37 switches between the open state and the closed state to thereby switch between fluid communication and interruption of the refrigerant line 34. By so doing, the on-off valve 37 allows or prohibits flow of refrigerant through the refrigerant line 34. The on-off valve 37 is provided in the refrigerant line 34 that is the path of refrigerant flowing out from the cooling portion 30, and has the function of a first on-off valve that is able to open or close the refrigerant line 34.

An on-off valve 38 that is able to open or close the refrigerant line 35 is provided in the refrigerant line 35. The on-off valve 38 switches between the open state and the closed state to thereby switch between fluid communication and interruption of the refrigerant line 35. By so doing, the on-off valve 38 allows or prohibits flow of refrigerant through the refrigerant line 35. The on-off valve 38 is provided in the refrigerant line 35 that is the path of refrigerant flowing out from the cooling portion 30, and has the function of a second on-off valve that is able to open or close the refrigerant line 35.

The on-off valve 37 and the on-off valve 38 constitute a selector valve 36 that serves as a second selector valve. The selector valve 36 switches between flow of refrigerant from the cooling portion 30 toward the heat exchanger 14 via the refrigerant line 34 and flow of refrigerant from the cooling portion 30 toward the heat exchanger 15 via the refrigerant line 35. The configuration is not limited to the example in which the selector valve 36 is formed of the two on-off valves 37 and 38. For example, it is applicable that a three-way valve connected to a branching point between the refrigerant lines 34 and 35 is provided and then the three-way valve switches between the open state and the closed state to thereby function as the selector valve 36.

The flow regulating valve 42 is provided in the refrigerant line 23 that forms one of the refrigerant paths, which does not pass through the cooling portion 30, between the refrigerant paths connected in parallel between the heat exchanger 14 and the gas-liquid separator 80. The flow regulating valve 42 changes its valve opening degree to increase or reduce the pressure loss of refrigerant flowing through the flow regulating valve 42. By so doing, the flow regulating valve 42 selectively adjusts the flow rate of refrigerant directly flowing between the gas-liquid separator 80 and the heat exchanger 14 without passing through the cooling portion 30 and the flow rate of refrigerant flowing via the cooling system for cooling the EV device 31, including the cooling line 32.

When the valve opening degree of the flow regulating valve 42 is increased, the flow rate of refrigerant that flows directly to the heat exchanger 14 via the refrigerant line 23 increases and the flow rate of refrigerant that flows to the cooling line 32 via the refrigerant line 33 to cool the EV device 31 reduces within refrigerant that flows from the gas-liquid separator 80 to the heat exchanger 14. When the valve opening degree of the flow regulating valve 42 is reduced, the flow rate of refrigerant that directly flows to the heat exchanger 14 via the refrigerant line 23 reduces and the flow rate of refrigerant that flows to the cooling line 32 to cool the EV device 31 increases within refrigerant that flows from the gas-liquid separator 80 to the heat exchanger 14.

The flow regulating valve 43 is provided in the refrigerant line 24 that forms one of the refrigerant path, which does not pass through the cooling portion 30, between the refrigerant paths connected in parallel between the gas-liquid separator 80 and the heat exchanger 15. The flow regulating valve 43 changes its valve opening degree to increase or reduce the pressure loss of refrigerant flowing through the flow regulating valve 43. By so doing, the flow regulating valve 43 selectively adjusts the flow rate of refrigerant directly flowing between the gas-liquid separator 80 and the heat exchanger 15 without passing through the cooling portion 30 and the flow rate of refrigerant flowing via the cooling system for cooling the EV device 31, including the cooling line 32.

When the valve opening degree of the flow regulating valve 43 is increased, the flow rate of refrigerant that flows directly to the heat exchanger 15 via the refrigerant line 24 increases and the flow rate of refrigerant that flows to the cooling line 32 via the refrigerant line 33 to cool the EV device 31 reduces within refrigerant that flows from the gas-liquid separator 80 to the heat exchanger 15. When the valve opening degree of the flow regulating valve 43 is reduced, the flow rate of refrigerant that directly flows to the heat exchanger 15 via the refrigerant line 24 reduces and the flow rate of refrigerant that flows to the cooling line 32 to cool the EV device 31 increases within refrigerant that flows from the gas-liquid separator 80 to the heat exchanger 15.

As the valve opening degrees of the flow regulating valves 42 and 43 are increased, the flow rate of refrigerant that cools the EV device 31 reduces, so cooling performance for cooling the EV device 31 decreases. As the valve opening degrees of the flow regulating valves 42 and 43 reduce, the flow rate of refrigerant that cools the EV device 31 increases, so cooling performance for cooling the EV device 31 improves. The flow regulating valves 42 and 43 are used to make it possible to optimally adjust the amount of refrigerant flowing to the EV device 31, so it is possible to appropriately control the temperature of the EV device 31 and, therefore, it is possible to reliably prevent excessive heating and excessive cooling of the EV device 31. In addition, it is possible to reliably reduce pressure loss associated with flow of refrigerant in the cooling system for cooling the EV device 31 and the power consumption of the compressor 12 for circulating refrigerant.

The heat exchangers 13 and 18 are arranged inside the duct 90 through which air-conditioning air flows. The duct 90 has a duct inlet 91 and a duct outlet 92. The duct inlet 91 is an inlet through which air-conditioning air flows into the duct 90. The duct outlet 92 is an outlet through which air-conditioning air flows out from the duct 90. A fan 93 is arranged near the duct inlet 91 inside the duct 90.

By driving the fan 93, flow of air is generated inside the duct 90. As the fan 93 operates, air-conditioning air flows into the duct 90 via the duct inlet 91. The heat exchanger 18 is arranged at the upstream side of flow of air-conditioning air inside the duct 90, and the heat exchanger 13 is arranged at the downstream side of flow of air-conditioning air inside the duct 90. Air flowing into the duct 90 may be outside air or may be air in the cabin of the vehicle. The arrow 97 in FIG. 1 indicates flow of air-conditioning air that flows via the heat exchanger 18. The arrow 98 indicates flow of air-conditioning air that flows out from the duct 90 via the duct outlet 92.

A partition wall 94 is arranged inside the duct 90. The partition wall 94 partitions the internal space of the duct 90 into two spaces. The partition wall 94 extends in a direction in which air flows inside the duct 90, and separates flow of air-conditioning air flowing inside the duct 90 into two flows. The heat exchanger 18 is arranged at the upstream side of flow of air-conditioning air with respect to the partition wall 94. The heat exchanger 13 is arranged in one of the two spaces partitioned by the partition wall 94.

A damper 96 is provided on the upstream side of the partition wall 94. The damper 96 has the function of a flow regulating unit that adjusts the flow rate of air-conditioning air flowing to each of the two spaces partitioned by the partition wall 94. An actuator 95 that drives the damper 96 is provided at the upstream-side end portion of the partition wall 94. The damper 96 is supported by the actuator 95 at its one end, and is rotatable in both directions about an axis that coincides with the one end. In response to arrangement of the damper 96, the case where air-conditioning air flows via the heat exchanger 13 and the case where air-conditioning air flows while bypassing the heat exchanger 13 are switched, and the temperature of air-conditioning air at the duct outlet 92 is adjusted.

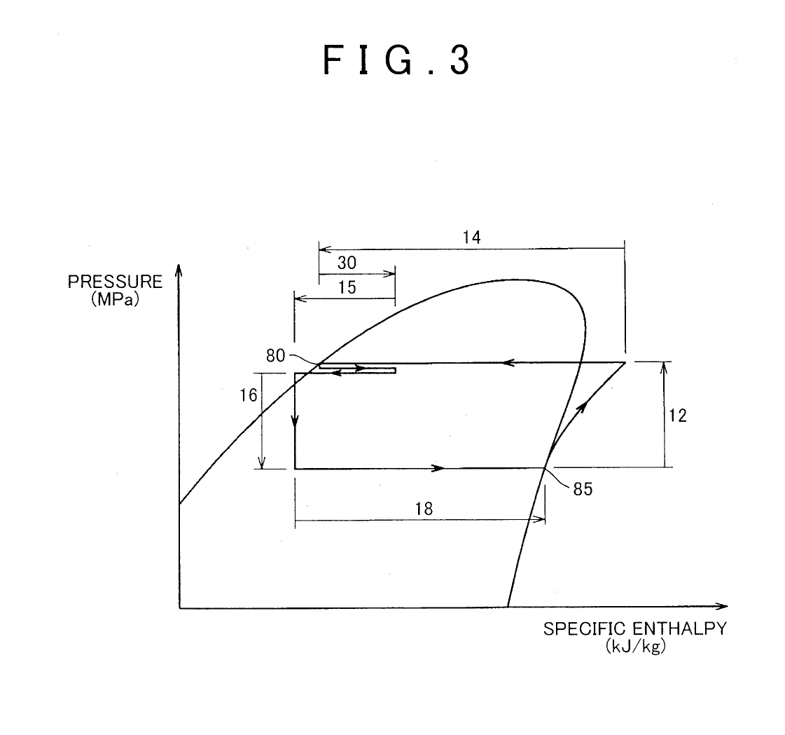

In the arrangement of the damper 96 shown in FIG. 1, the damper 96 blocks flow of air-conditioning air flowing toward the heat exchanger 13. Therefore, air-conditioning air flows inside the duct 90 without passing through the heat exchanger 13. In this case, air-conditioning air is prevented from being heated by the heat exchanger 13, and air-conditioning air is kept at a low temperature. On the other hand, in the arrangement of the damper 96 shown in FIG. 4 (described later), the damper 96 guides flow of air-conditioning air toward the heat exchanger 13. In, this case, heat is transferred from refrigerant adiabatically compressed in the compressor 12 to air-conditioning air at the heat exchanger 13, and air-conditioning air is heated.

The flow regulating unit for adjusting the flow rate of air-conditioning air that passes through the heat exchanger 13 is not limited to the damper 96. For example, it is applicable that a roll screen flow regulating unit is installed inside the duct 90 and then flow of air-conditioning air is controlled by changing the take-up amount of screen.

The cooling system 1 further includes a three-way valve 41 that serves as a first selector valve. The refrigerant line 22 that provides fluid communication between the heat exchanger 13 and the heat exchanger 14 includes a refrigerant line 22a and a refrigerant line 22b. The refrigerant line 22a provides fluid communication between the heat exchanger 13 and the three-way valve 41. The refrigerant line 22b provides fluid communication between the three-way valve 41 and the heat exchanger 14. The cooling system 1 further includes a refrigerant line 71, an expansion valve 76 and refrigerant lines 72, 73 and 74. The refrigerant line 71 is coupled to the three-way valve 41. The expansion valve 76 decompresses refrigerant flowing through the refrigerant line 71. Refrigerant throttle-expanded by the expansion valve 76 flows through the refrigerant lines 72, 73 and 74. The three-way valve 41 that has three line connecting ports is coupled to the refrigerant line 22a, the refrigerant line 22b and the refrigerant line 71. The refrigerant line 22a is connected to the first line connecting port of the three-way valve 41. The refrigerant line 22b is connected to the second line connecting port of the three-way valve 41. The refrigerant line 71 is connected to the third line connecting port of the three-way valve 41.

The refrigerant lines 73 and 74 are refrigerant paths that branch off from the refrigerant line 72. The refrigerant line 73 that serves as a first branching line provides fluid communication between the refrigerant line 72 and the refrigerant line 25. An on-off valve 77 that is able to open or close the refrigerant line 73 is provided in the refrigerant line 73. The on-off valve 77 switches between the open state and the closed state to thereby switch between fluid communication and interruption of the refrigerant line 73. By so doing, the on-off valve 77 allows or prohibits flow of refrigerant through the refrigerant line 73. The refrigerant line 74 that serves as a second branching line provides fluid communication between the refrigerant line 72 and the refrigerant line 26. An on-off valve 78 that is able to open or close the refrigerant line 74 is provided in the refrigerant line 74. The on-off valve 78 switches between the open state and the closed state to thereby switch between fluid communication and interruption of the refrigerant line 74. By so doing, the on-off valve 78 allows or prohibits flow of refrigerant through the refrigerant line 74.

The refrigerant lines 71, 72 and 73 provide fluid communication between the refrigerant line 22 that is the refrigerant path between the heat exchanger 13 and the heat exchanger 14 and the refrigerant line 25 that is the refrigerant path between the heat exchanger 15 and the expansion valve 16. The refrigerant lines 71, 72 and 74 provide fluid communication between the refrigerant line 22 and the refrigerant line 26 that is the refrigerant path between the expansion valve 16 and the heat exchanger 18.

The three-way valve 41 switches a fluid communication state between the refrigerant line 22a and the refrigerant line 22b and switches a fluid communication state between the refrigerant line 22a and the refrigerant line 71. The three-way valve 41 switches between a first state and a second state. In the first state, the refrigerant line 22a and the refrigerant line 22b are in fluid communication with each other, and the refrigerant line 22a and the refrigerant line 71 are not in fluid communication with each other. In the second state, the refrigerant line 22a and the refrigerant line 71 are in fluid communication with each other, and the refrigerant line 22a and the refrigerant line 22b are not in fluid communication with each other.

Refrigerant adiabatically compressed in the compressor 12 passes through the refrigerant line 21, the heat exchanger 13 and the refrigerant line 22a and reaches the three-way valve 41. The refrigerant flows from the three-way valve 41 to the heat exchanger 14 via the refrigerant line 22b. In addition, the refrigerant flows from the three-way valve 41 to the heat exchanger 15 via the refrigerant line 71, the expansion valve 76, the refrigerant lines 72 and 73 and the refrigerant line 25 sequentially. In addition, the refrigerant flows from the three-way valve 41 to the heat exchanger 18 via the refrigerant line 71, the expansion valve 76, the refrigerant lines 72 and 74 and the refrigerant line 26 sequentially. The three-way valve 41 has the function of a path selecting unit that switches between the open state and the closed state to selectively switch between flow of refrigerant from the heat exchanger 13 toward the heat exchanger 14 and flow of refrigerant from the heat exchanger 13 toward the heat exchanger 15 and/or the heat exchanger 18.

The expansion valve 76 has the function of another decompressor different from the expansion valve 16, and decompresses refrigerant flowing through the refrigerant line 71. The expansion valve 76 throttle-expands refrigerant flowing through the refrigerant line 71, and decreases the pressure of refrigerant. By so doing, in comparison with refrigerant flowing inside the refrigerant line 71, refrigerant flowing through the refrigerant line 72 has a lower pressure. The expansion valve 76 may be an electronic expansion valve. Alternatively, the other decompressor may not have an opening degree regulating function, and a thin capillary tube may be provided instead of the expansion valve 76.

The cooling system 1 includes a refrigerant line 61 that provides fluid communication between the refrigerant line 22b and the refrigerant line 28. The refrigerant line 22b that serves as a sixth line constitutes a path of refrigerant that flows into or flows out from the heat exchanger 14 together with the refrigerant line 23. An on-off valve 64 that is able to open or close the refrigerant line 61 is provided in the refrigerant line 61. The on-off valve 64 switches between the open state and the closed state to thereby switch between fluid communication and interruption of the refrigerant line 61. By so doing, the on-off valve 64 allows or prohibits flow of refrigerant through the refrigerant line 61.

A check valve 66 is further provided in the refrigerant line 61. The check valve 66 is provided in the refrigerant line 61 at a location closer to the refrigerant line 28 than the on-off valve 64. The check valve 66 prohibits flow of refrigerant from the refrigerant line 28 toward the on-off valve 64. The check valve 66 is provided in order to prevent refrigerant flowing from the heat exchanger 18 via the refrigerant lines 27 and 28 from flowing into the refrigerant line 61 and to reliably flow refrigerant from the refrigerant line 28 to the accumulator 85.

The cooling system 1 further includes a communication line 51. The communication line 51 provides fluid communication between the refrigerant line 22b and the outlet side of the cooling portion 30. The refrigerant line 22b provides fluid communication between the three-way valve 41 and the heat exchanger 14. An on-off valve 52 that is able to open or close the communication line 51 is provided in the communication line 51. The on-off valve 52 switches between the open state and the closed state to thereby switch between fluid communication and interruption of the communication line 51. By so doing, the on-off valve 52 allows or prohibits flow of refrigerant through the communication line 51.

By opening or closing the on-off valve 52 to switch the path of refrigerant flowing out from the cooling portion 30, it is possible to cause refrigerant after cooling the EV device 31 to flow to the heat exchanger 14 via the communication line 51 and the refrigerant line 22b. That is, refrigerant flowing out from the cooling portion 30 is able to flow to the heat exchanger 14 via the refrigerant lines 34 and 23a; and is able to flow to the heat exchanger 15 via the refrigerant lines 35 and 24b, and is able to further flow to the heat exchanger 14 via the communication line 51 and the refrigerant line 22b.

Instead of the configuration that the on-off valve 52 is provided in the communication line 51, a four-way valve that has four line connecting ports may be provided at a branching point among the refrigerant lines 34 and 35 and the communication line 51. In this case, the refrigerant lines 34 and 35 and the communication line 51 are respectively connected to the line connecting ports of the four-way valve, and, by switching the settings of open/close states of the four-way valve, it is possible to select any one of the refrigerant line 34, the refrigerant line 35 and the communication line 51 as the path of refrigerant that flows out from the cooling portion 30.

The flow regulating valves 42 and 43 each are configured to be able to adjust its opening degree, and each may be, for example, an electric valve. The on-off valves 37, 38, 44, 52, 64, 77 and 78 each just need to be configured to be able to switch between a fully open state and a fully closed state, and each may be, for example, an electromagnetic valve.

### First Operation Mode

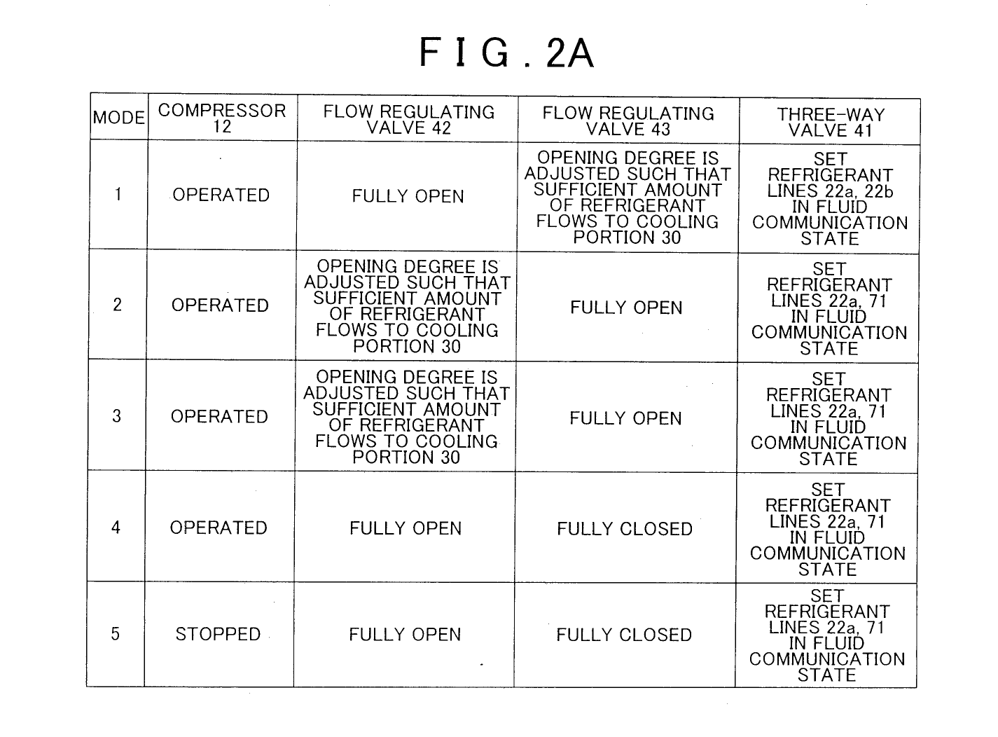

The cooling system 1 according to the present embodiment is able to cool the EV device 31 that serves as the heat generating source in five first to fifth operation modes. FIG. 1 shows a state where the cooling system 1 is set in the first operation mode. FIGS. 2A and 2B are views that show settings of the compressor and valves in each operation mode of the cooling system 1.

FIGS. 2A and 2B show the operation status of the compressor 12 and settings of the opening degrees of the flow regulating valves 42 and 43, the three-way valve 41 and the on-off valves 37, 38, 44, 52, 64, 77 and 78 in each operation mode in the case where the cooling system 1 is operated in any one of the different five operation modes. FIG. 2B further shows the temperature regulating action of the EV device 31 and the state of air conditioning inside the vehicle cabin using an air conditioner in each operation mode of the cooling system 1.

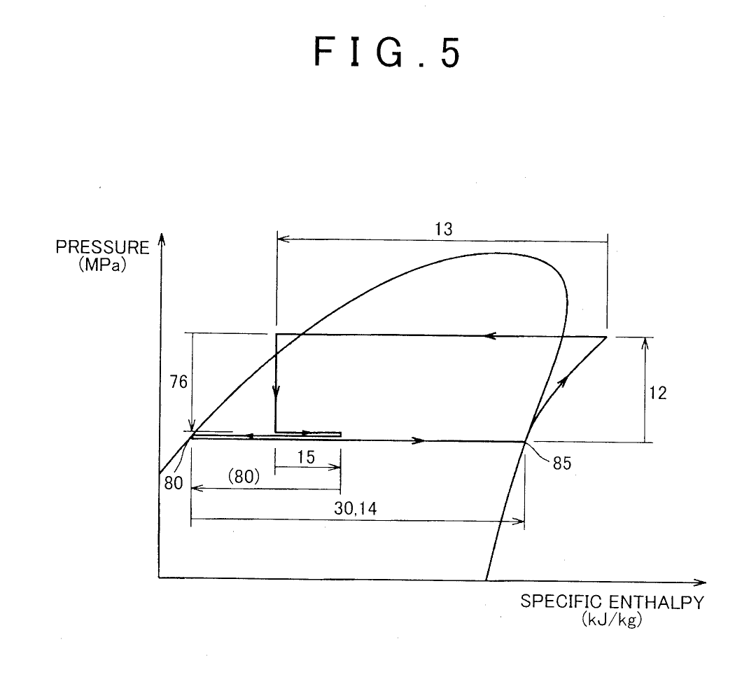

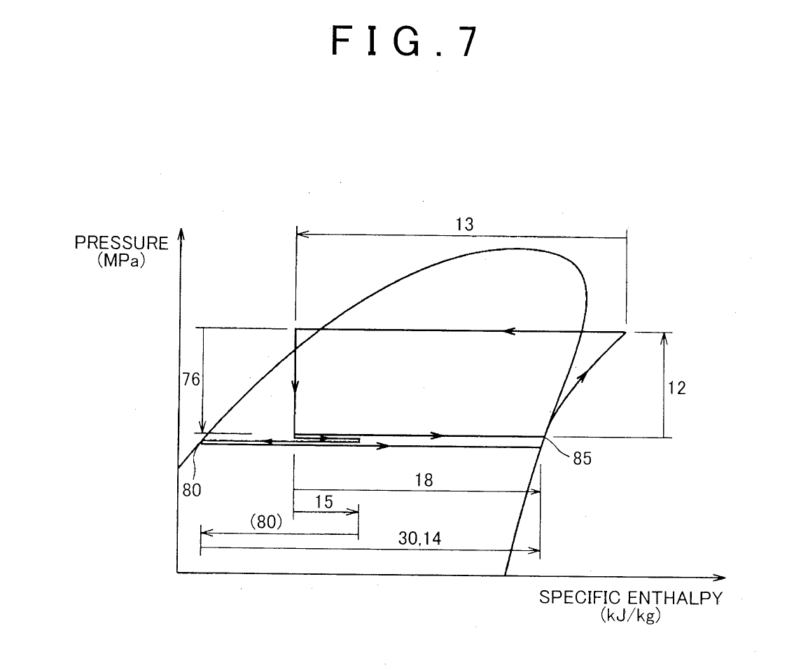

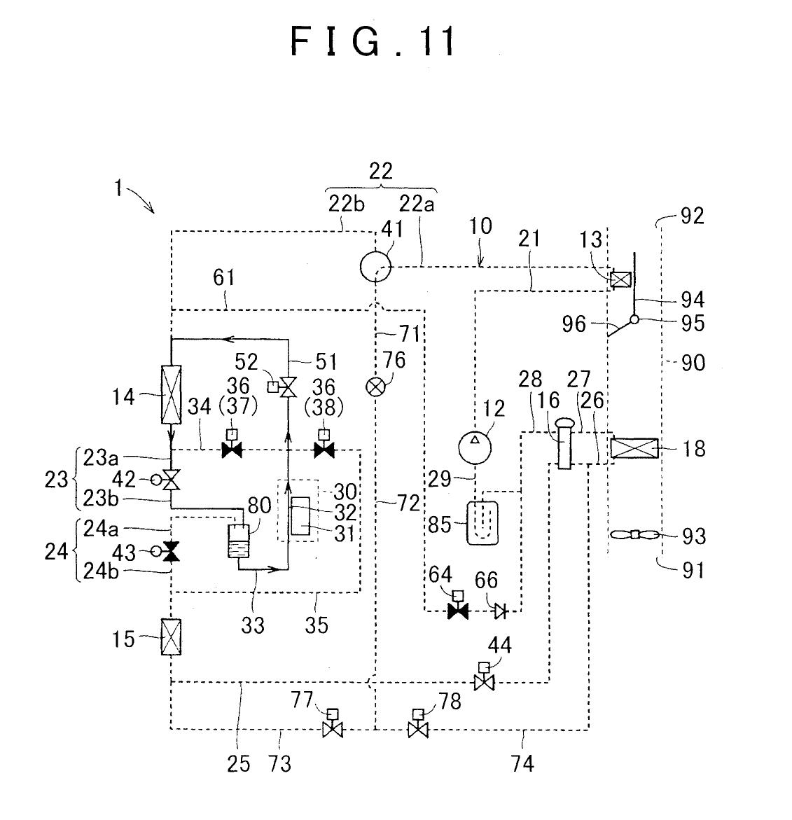

Among the operation modes shown in FIGS. 2A and 2B, the first operation mode is an operation mode in which the vehicle cabin is cooled and dehumidified during operation of the air conditioner for cooling the cabin of the vehicle. Note that in FIG. 1 and FIG. 4, FIG. 6, FIG. 8 and FIG. 11 (described later), refrigerant flows through the refrigerant path indicated by the solid line, and refrigerant does not flow through the refrigerant path indicated by the dotted line.

In the first operation mode, refrigerant is required to flow through a path that includes the expansion valve 16 and the heat exchanger 18 in order to cool the vehicle cabin, so the compressor 12 is in an operating state. The flow regulating valve 42 is fully open so as to minimize the pressure loss of refrigerant flowing through the refrigerant line 23. The flow regulating valve 43 adjusts the flow rate of refrigerant flowing through the cooling portion 30, and the valve opening degree of the flow regulating valve 43 is adjusted such that a sufficient amount of refrigerant flows to the cooling portion 30 in order to cool the EV device 31. The open/close state of the three-way valve 41 is switched such that the refrigerant line 22a and the refrigerant line 22b are in fluid communication with each other and the refrigerant line 71 is not in fluid communication with both the refrigerant lines 22a and 22b.

The on-off valve 37 is closed, and the refrigerant line 34 is interrupted. The on-off valve 38 is opened, and the refrigerant line 35 is set in a fluid communication state. The on-off valve 52 is closed, and the communication line 51 is interrupted. The open/close states of the selector valve 36 and on-off valve 52 are switched such that refrigerant flowing out from the cooling portion 30 flows to the refrigerant line 35 and does not flow to the refrigerant line 34 and the communication line 51. The on-off valve 44 is opened, and the refrigerant line 25 is set in a fluid communication state. The on-off valves 64, 77 and 78 each are closed, and the refrigerant lines 61, 73 and 74 are interrupted.

Refrigerant passes through a refrigerant circulation path that is formed by sequentially connecting the compressor 12, the heat exchangers 14 and 15, the expansion valve 16 and the heat exchanger 18 by the refrigerant lines 21 to 29 to circulate in the vapor compression refrigeration cycle 10.

During cooling operation shown in FIG. 1, it is required to keep the temperature of air-conditioning air flowing out from the duct 90 low. Therefore, by operating the damper 96, the path of air-conditioning air inside the duct 90 is set such that air-conditioning air does not pass through the heat exchanger 13. By so doing, it is possible to suppress a decrease in cooling performance due to heating of air-conditioning air by the heat exchanger 13, so it is possible to efficiently cool the cabin of the vehicle, and, therefore, it is possible to ensure cooling performance.

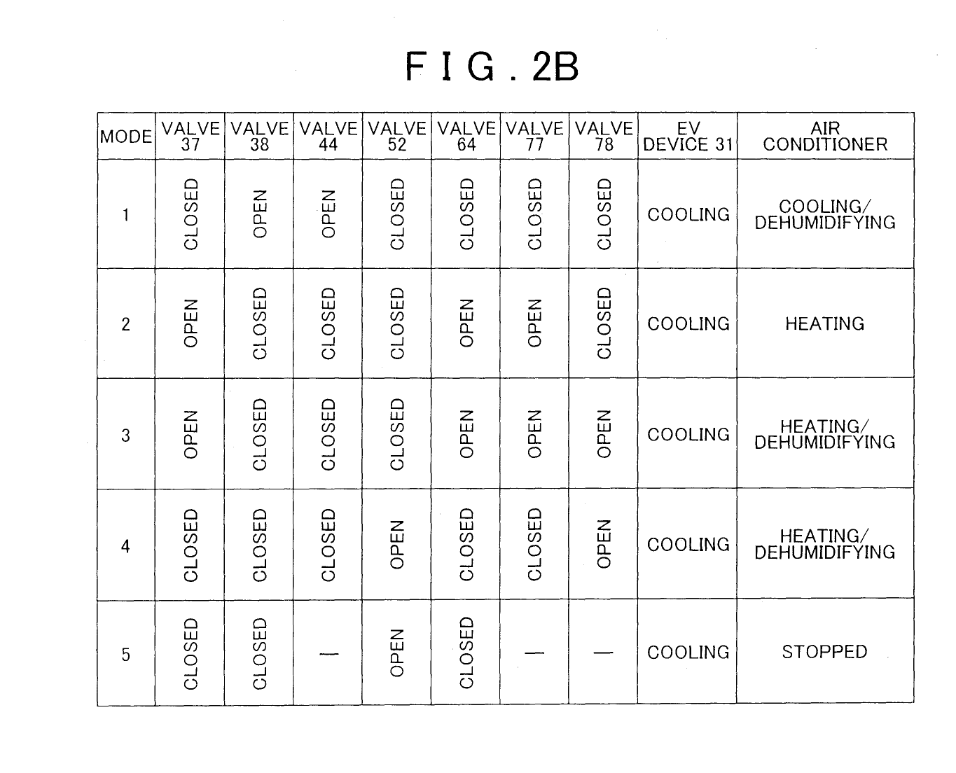

FIG. 3 is a Mollier chart that shows the state of refrigerant in the vapor compression refrigeration cycle 10 in the first operation mode. In FIG. 3, the abscissa axis represents the specific enthalpy of refrigerant, and the ordinate axis represents the absolute pressure of refrigerant. The unit of the specific enthalpy is kJ/kg, and the unit of the absolute pressure is MPa. The curve in the chart is the saturation vapor line and saturation liquid line of refrigerant.

FIG. 3 shows the thermodynamic state of refrigerant at points in the vapor compression refrigeration cycle 10 when refrigerant flows from the refrigerant line 23 at the outlet of the heat exchanger 14 to the refrigerant line 33 via the gas-liquid separator 80, flows into the cooling portion 30 to cool the EV device 31 and returns from the cooling portion 30 to the refrigerant line 24b at the inlet of the heat exchanger 15 via the refrigerant line 35.

As shown in FIG. 3, refrigerant in a saturated steam state is introduced from the accumulator 85 into the compressor 12, and the refrigerant is adiabatically compressed in the compressor 12 along a constant specific entropy line. As refrigerant is compressed in the compressor. 12, the refrigerant increases in pressure and temperature into high-temperature and high-pressure superheated steam having a high degree of superheat at the outlet of the compressor 12.

High-temperature and high-pressure refrigerant in a superheated steam state, adiabatically compressed in the compressor 12, flows to the heat exchanger 14 and is cooled in the heat exchanger 14. High-pressure gaseous refrigerant discharged from the compressor 12 releases heat to the surroundings to be cooled in the heat exchanger 14 to thereby condense (liquefy). Through heat exchange with outside air in the heat exchanger 14, the temperature of refrigerant decreases, and refrigerant liquefies. High-pressure refrigerant steam in the heat exchanger 14 becomes dry saturated steam from superheated steam with a constant pressure in the heat exchanger 14, and releases latent heat of condensation to gradually liquefy into wet steam in a gas-liquid mixing state.

In the gas-liquid separator 80, refrigerant in a gas-liquid two-phase state is separated into refrigerant steam in a saturated steam state and refrigerant liquid in a saturated liquid state. Refrigerant in a saturated liquid state flows out from the gas-liquid separator 80, flows to the cooling line 32 of the cooling portion 30 via the refrigerant line 33, and cools the EV device 31. In the cooling portion 30, heat is released to liquid refrigerant in a saturated liquid state, which is condensed in the heat exchanger 14 and is separated in the gas-liquid separator 80, to thereby cool the EV device 31. Refrigerant is heated by exchanging heat with the EV device 31, and the dryness of the refrigerant increases. Refrigerant receives latent heat from the EV device 31 to partially vaporize into wet steam in a gas-liquid two-phase state, which mixedly contains saturated liquid and saturated steam at the outlet of the cooling portion 30.

Refrigerant flowing out from the cooling portion 30 flows into the heat exchanger 15 via the refrigerant lines 35 and 24b. Wet steam of refrigerant releases heat to surroundings to exchange heat with outside air in the heat exchanger 15 to be cooled to thereby condense again, becomes saturated liquid as the entire refrigerant condenses, and further releases sensible heat to become supercooled liquid. Refrigerant is cooled to below a saturated temperature in the heat exchanger 15. After that, the refrigerant flows into the expansion valve 16 via the refrigerant line 25. In the expansion valve 16, refrigerant in a supercooled liquid state is throttle-expanded, and the refrigerant decreases in temperature and pressure with the specific enthalpy unchanged to become low-temperature and low-pressure wet steam in a gas-liquid mixing state.

Refrigerant in a wet steam state from the expansion valve 16 flows into the heat exchanger 18 via the refrigerant line 26. Refrigerant in a wet steam state flows into the tubes of the heat exchanger 18. Atomized refrigerant flowing inside the heat exchanger 18 vaporizes to absorb heat of air-conditioning air that is introduced so as to contact with the heat exchanger 18. The heat exchanger 18 uses low-temperature and low-pressure refrigerant decompressed by the expansion valve 16 to absorb heat of vaporization, which is required at the time when wet steam of refrigerant evaporates into refrigerant gas, from air-conditioning air flowing to the cabin of the vehicle to thereby cool the cabin of the vehicle. Air-conditioning air of which heat is absorbed by the heat exchanger 18 to decrease in temperature flows into the cabin of the vehicle to cool the cabin of the vehicle.

When refrigerant flows through the tubes of the heat exchanger 18, the refrigerant absorbs heat of air-conditioning air as latent heat of vaporization via the fins to be heated and evaporate with a constant pressure. During cooling operation, air-conditioning air is cooled in the heat exchanger 18 through heat exchange between high-temperature air-conditioning air and refrigerant, the temperature of air-conditioning air decreases, and refrigerant receives heat transferred from air-conditioning air to be heated.

In response to cooling performance required to cool the vehicle cabin, the amount of heat that is exchanged between refrigerant and air-conditioning air in the heat exchanger 18 changes. In the heat exchanger 18, refrigerant may be heated until all the refrigerant becomes superheated steam, refrigerant may be heated until all the refrigerant becomes dry saturated steam or refrigerant may be in a wet saturated steam state at the outlet of the heat exchanger 18. When refrigerant flowing out from the heat exchanger 18 contains liquid refrigerant, refrigerant liquid is stored in the accumulator 85, and only gaseous refrigerant steam is introduced into the compressor 12. By so doing, refrigerant liquid is prevented from flowing into the compressor 12. FIG. 3 shows the state of refrigerant when refrigerant in a wet saturated steam state is separated into gas and liquid in the accumulator 85 and refrigerant in a dry saturated steam state flows out from the accumulator 85 to the compressor 12 via the refrigerant line 29.

Refrigerant continuously repeats changes among the compressed state, the condensed state, the throttle-expanded state and the evaporated state in accordance with the above-described cycle. Note that, in the above description of the vapor compression refrigeration cycle, a theoretical refrigeration cycle is described; however, in the actual vapor compression refrigeration cycle 10, it is, of course, necessary to consider a loss in the compressor 12, a pressure loss of refrigerant and a heat loss.

During operation of the vapor compression refrigeration cycle 10, refrigerant absorbs heat of vaporization from air in the cabin of the vehicle at the time when the refrigerant evaporates in the heat exchanger 18 that serves as an evaporator to thereby cool the cabin. In addition, high-pressure liquid refrigerant condensed in the heat exchanger 14 and separated by the gas-liquid separator 80 flows to the cooling portion 30 and exchanges heat with the EV device 31 to thereby cool the EV device 31. The cooling system 1 cools the EV device 31, which is the heat generating source mounted on the vehicle, by utilizing the vapor compression refrigeration cycle 10 for air-conditioning the cabin of the vehicle. Note that the temperature required to cool the EV device 31 is desirably at least lower than the upper limit of a target temperature range of the EV device 31.

The vapor compression refrigeration cycle 10 that is provided in order to cool a cooled portion in the heat exchanger 18 is utilized to cool the EV device 31, so it is not necessary to provide a device, such as an exclusive water circulation pump and a cooling fan, in order to cool the EV device 31. Therefore, components required for the cooling system 1 to cool the EV device 31 may be reduced to make it possible to simplify the system configuration, so the manufacturing cost of the cooling system 1 may be reduced. In addition, it is not necessary to operate a power source, such as a pump and a cooling fan, in order to cool the EV device 31, and power consumption for operating the power source is not required. Thus, it is possible to reduce power consumption for cooling the EV device 31, so it is possible to cool the EV device 31 at a low power.

In the heat exchanger 14, refrigerant just needs to be cooled into a wet saturated steam state. Refrigerant in a saturated liquid state, which is separated by the gas-liquid separator 80, is supplied to the cooling portion 30. Refrigerant in a wet steam state, which receives latent heat of vaporization from the EV device 31 to be partially vaporized, is cooled again in the heat exchanger 15. Refrigerant changes in state at a constant temperature until the refrigerant in a wet steam state completely condenses into saturated liquid. The heat exchanger 15 further supercools liquid refrigerant to a degree of supercooling required to cool the cabin of the vehicle. A degree of supercooling of refrigerant does not need to be excessively increased, so the capacity of each of the heat exchangers 14 and 15 may be reduced. Thus, the cooling performance for cooling the cabin may be ensured, and the size of each of the heat exchangers 14 and 15 may be reduced, so it is possible to obtain the cooling system 1 that is reduced in size and that is advantageous in installation on the vehicle.

At the time when the specifications of each of the heat exchangers 14 and 15 are determined in the design step of the cooling system 1, the maximum heat generation amount of the EV device 31 is used as a designed value. During normal heat generation in which the EV device 31 generates the amount of heat smaller than the maximum heat generation amount, there is an allowance for the performance of each of the heat exchangers 14 and 15. Therefore, once in a state where not the EV device 31 that generates the maximum heat generation amount is cooled, refrigerant is able to exchange heat with a larger amount of air in each of the heat exchangers 14 and 15. This may be understood that the heat exchangers 14 and 15 each apparently increase in size and the temperature efficiency φc of each of the heat exchangers 14 and 15 becomes higher.

An air-side heat radiation performance Qca in each of the heat exchangers 14 and 15 is directly proportional to the temperature efficiency φc of the heat exchanger, an air specific heat Ca, an air volume by weight Gea and a difference (Ter−Tea) obtained by subtracting an intake air temperature Tea from a refrigerant temperature Ter. The required heat radiation performance Qca is unchanged, and the air specific heat Ca, the air volume by weight Gea and the intake air temperature Tea are determined in accordance with an outside air temperature and a vehicle speed, so the refrigerant temperature Ter decreases by the amount of increase in the temperature efficiency φc. Referring to the Mollier chart, when refrigerant is in a gas-liquid two-phase state, the temperature and pressure of refrigerant linearly correlate with each other, and the temperature of refrigerant varies with a variation in the pressure of refrigerant. That is, a decrease in the refrigerant temperature Ter in the heat exchangers 14 and 15 means a decrease in the pressure of refrigerant flowing through the heat exchangers 14 and 15.

The pressure of refrigerant in the heat exchangers 14 and 15 decreases, and the high pressure of the vapor compression refrigeration cycle 10 decreases. As a result, the pressure of refrigerant at the outlet of the compressor 12 may be relatively low. Therefore, it is possible to reduce power for adiabatically compressing refrigerant in the compressor 12, so it is possible to achieve further power saving. Thus, it is possible to improve the fuel consumption of the vehicle. Particularly, in an electric vehicle, it is possible to directly improve electric power consumption through power saving.

The refrigerant line 24 that forms a refrigerant path not passing through the cooling portion 30 and the refrigerant lines 33 and 35 and cooling line 32 that form a refrigerant path passing through the cooling portion 30 to cool the EV device 31 are provided in parallel with each other as the paths of refrigerant flowing from the gas-liquid separator 80 toward the heat exchanger 15. The cooling system for cooling the EV device 31, including the refrigerant lines 33 and 35, is connected in parallel with the refrigerant line 24. Therefore, only part of refrigerant flowing out from the gas-liquid separator 80 flows to the cooling portion 30. By adjusting the opening degree of the flow regulating valve 43 provided in the refrigerant line 24, the flow rate of refrigerant flowing from the gas-liquid separator 80 to the refrigerant line 24 and the flow rate of refrigerant flowing through the cooling portion 30 are appropriately adjusted. Through the flow rate adjustment, an amount of refrigerant required to cool the EV device 31 flows to the cooling portion 30, and the EV device 31 is appropriately cooled.

The path of refrigerant that flows from the heat exchanger 14 to the heat exchanger 15 without passing through the cooling portion 30 and the path of refrigerant that flows from the heat exchanger 14 to the heat exchanger 15 via the cooling portion 30 are provided in parallel with each other, and only part of refrigerant is caused to flow to the refrigerant lines 33 and 35. By so doing, it is possible to reduce the pressure loss at the time when refrigerant flows through the cooling system for cooling the EV device 31. Not the entire refrigerant flows to the cooling portion 30. Therefore, it is possible to reduce the pressure loss associated with flow of refrigerant via the cooling portion 30, and, accordingly, it is possible to reduce power consumption required to operate the compressor 12 for circulating refrigerant.

When low-temperature and low-pressure refrigerant after passing through the expansion valve 16 is used to cool the EV device 31, the cooling performance of air in the cabin in the heat exchanger 18 reduces and the cooling performance for cooling the cabin decreases In contrast to this, in the cooling system 1 according to the present embodiment, in the vapor compression refrigeration cycle 10, high-pressure refrigerant discharged from the compressor 12 is condensed by both the heat exchanger 14 that serves as a first condenser and the heat exchanger 15 that serves as a second condenser. The two-stage heat exchangers 14 and 15 are arranged between the compressor 12 and the expansion valve 16, and the cooling portion 30 for cooling the EV device 31 is provided between the heat exchanger 14 and the heat exchanger 15. The heat exchanger 15 is provided in the path of refrigerant flowing from the cooling, portion 30 toward the expansion valve 16.

By sufficiently cooling refrigerant, which receives latent heat of vaporization from the EV device 31 to be heated, in the heat exchanger 15, the refrigerant has a temperature and a pressure that are originally required to cool the cabin of the vehicle at the outlet of the expansion valve 16. Therefore, it is possible to sufficiently increase the amount of heat externally received when refrigerant evaporates in the heat exchanger 18, so it is possible to sufficiently cool air-conditioning air that passes through the heat, exchanger 18. In this way, by setting the heat radiation performance for the heat exchanger 15 such that the heat exchanger 15 is able to sufficiently cool refrigerant, the EV device 31 may be cooled without any influence on the cooling performance for cooling the cabin. Thus, both the cooling performance for cooling the EV device 31 and the cooling performance for cooling the cabin may be reliably ensured.

When refrigerant flowing from the heat exchanger 14 to the cooling portion 30 cools the EV device 31, the refrigerant receives heat from the EV device 31 to be heated. As refrigerant is heated to a saturated steam temperature or above and the entire amount of the refrigerant vaporizes in the cooling portion 30, the amount of heat exchanged between the refrigerant and the EV device 31 reduces, and the EV device 31 cannot be efficiently cooled, and, in addition, pressure loss at the time when the refrigerant flows in the line increases. Therefore, it is desirable to sufficiently cool refrigerant in the heat exchanger 14 such that the entire amount of refrigerant does not vaporize after cooling the EV device 31 and to supply a sufficient amount of liquid refrigerant to the gas-liquid separator 80.

Specifically, the state of refrigerant at the outlet of the heat exchanger 14 is brought close to saturated liquid, and, typically, refrigerant is placed in a state on the saturated liquid line at the outlet of the heat exchanger 14. Because the heat exchanger 14 is capable of sufficiently cooling refrigerant in this way, the heat radiation performance of the heat exchanger 14 for causing refrigerant to release heat is higher than the heat radiation performance of the heat exchanger 15. By sufficiently cooling refrigerant in the heat exchanger 14 having relatively high heat radiation performance, refrigerant that has received heat from the EV device 31 may be maintained in a wet steam state, and a reduction in the amount of heat exchanged between refrigerant and the EV device 31 may be avoided, so it is possible to sufficiently cool the EV device 31. Refrigerant in a wet steam state after cooling the EV device 31 is efficiently cooled again in the heat exchanger 15, and is cooled into a supercooled liquid state below a saturated temperature. Thus, it is possible to provide the cooling system 1 that ensures both the cooling performance for cooling the cabin and the cooling performance for cooing the EV device 31.

Refrigerant is caused to circulate in the vapor compression refrigeration cycle 10, and heat is taken from the EV device 31 due to latent heat of vaporization of refrigerant in a saturated liquid state, flowing to the cooling portion 30, so it is possible to efficiently cool the EV device 31. In addition, it is possible to cool air-conditioning air by supplying the heat exchanger 18 with refrigerant adjusted into a low-temperature and low-pressure atomized state by the expansion valve 16, so it is possible to ensure cooling performance for cooling the vehicle cabin and dehumidifying performance for dehumidifying the vehicle cabin.

### Second Operation Mode

FIG. 4 is a schematic view that shows the operation of the cooling system 1 in the second operation mode. As shown in FIG. 2A, FIG. 2B and FIG. 4, the second operation mode is an operation mode in which heating performance for heating the vehicle cabin is increased while the vehicle cabin is not dehumidified during operation of the air conditioner for heating the cabin of the vehicle.

In the second operation mode, refrigerant is required to flow through a path that includes the heat exchanger 13 in order to heat the vehicle cabin, so the compressor 12 is in an operating state. The flow regulating valve 42 adjusts the flow rate of refrigerant flowing through the cooling portion 30, and the valve opening degree of the flow regulating valve 42 is adjusted such that a sufficient amount of refrigerant flows to the cooling portion 30 in order to cool the EV device 31. The flow regulating valve 43 is fully opened so as to minimize the pressure loss of refrigerant flowing through the refrigerant line 24. The open/close state of the three-way valve 41 is switched such that the refrigerant line 22a and the refrigerant line 71 are in fluid communication with each other and the refrigerant line 22b is not in fluid communication with both the refrigerant lines 22a and 71.

The on-off valve 37 is opened, and the refrigerant line 34 is set in a fluid communication state. The on-off valve 38 is closed, and the refrigerant line 35 is interrupted. The on-off valve 52 is closed, and the communication line 51 is interrupted. The open/close states of the selector valve 36 and on-off valve 52 are switched such that refrigerant flowing out from the cooling portion 30 flows to the refrigerant line 34 and does not flow to the refrigerant line 35 and the communication line 51. The on-off valves 64 and 77 are opened, and the refrigerant lines 61 and 73 are set in a fluid communication state. The on-off valves 44 and 78 are closed, and the refrigerant lines 25 and 74 are interrupted.

Refrigerant passes through a refrigerant circulation path that is formed by sequentially connecting the compressor 12, the heat exchanger 13, the expansion valve 76 and the heat exchangers 15 and 14 by the refrigerant lines 21, 22a, 71, 72, 73, 25, 24, 23, 22b, 61 and 29 to circulate in the vapor compression refrigeration cycle 10.

During heating operation, it is required to increase the temperature of air-conditioning air flowing out from the duct 90. Therefore, as shown in FIG. 4, by operating the damper 96, the path of air-conditioning air inside the duct 90 is set such that air-conditioning air passes through the heat exchanger 13. By so doing, it is possible to heat air-conditioning air through heat exchange between high-temperature and high-pressure refrigerant adiabatically compressed in the compressor 12 and air-conditioning air, so it is possible to efficiently heat the cabin of the vehicle, and, therefore, it is possible to ensure heating performance for heating the vehicle cabin.

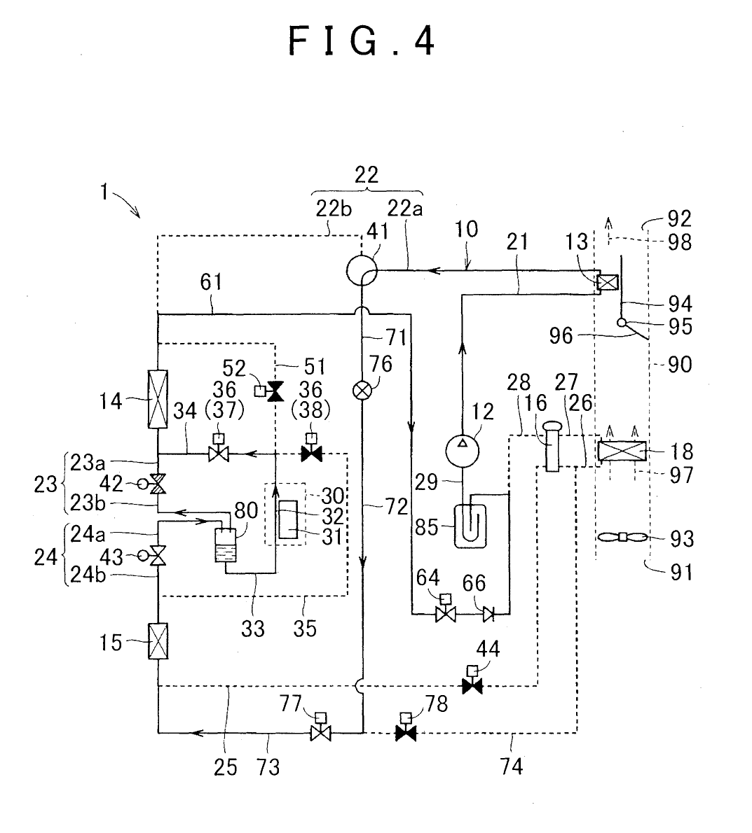

FIG. 5 is a Mollier chart that shows the state of refrigerant in the vapor compression refrigeration cycle 10 in the second operation mode. In FIG. 5, the abscissa axis represents the specific enthalpy of refrigerant, and the ordinate axis represents the absolute pressure of refrigerant. The unit of the specific enthalpy is kJ/kg, and the unit of the absolute pressure is MPa. The curve in the chart is the saturation vapor line and saturation liquid line of refrigerant.

FIG. 5 shows the thermodynamic state of refrigerant at points in the vapor compression refrigeration cycle 10 when refrigerant flows from the refrigerant line 24 at the outlet of the heat exchanger 15 to the refrigerant line 33 via the gas-liquid separator 80, flows into the cooling portion 30 to cool the EV device 31 and returns from the cooling portion 30 to the refrigerant line 23a at the inlet of the heat exchanger 14 via the refrigerant line 34.

As shown in FIG. 5, refrigerant in a saturated steam state is introduced from the accumulator 85 into the compressor 12, and the refrigerant is adiabatically compressed in the compressor 12 along a constant specific entropy line. As refrigerant is compressed in the compressor 12, the refrigerant increases in pressure and temperature into high-temperature and high-pressure superheated steam having a high degree of superheat at the outlet of the compressor 12, and flows to the heat exchanger 13.

High-pressure refrigerant steam in the heat exchanger 13 is cooled in the heat exchanger 13, becomes dry saturated steam from superheated steam with a constant pressure, releases latent heat of condensation to gradually liquefy into wet steam in a gas-liquid mixing state, becomes saturated liquid as the entire refrigerant condenses, and further releases sensible heat to become supercooled liquid. The heat exchanger 13 causes superheated refrigerant gas, compressed in the compressor 12, to release heat to air-conditioning air with a constant pressure and to become refrigerant liquid. Gaseous refrigerant discharged from the compressor 12 releases heat to air-conditioning air to be cooled in the heat exchanger 13 to thereby condense (liquefy). Owing to heat exchange in the heat exchanger 13, the temperature of refrigerant decreases, and refrigerant liquefies. During heating operation, low-temperature air-conditioning air and refrigerant exchange heat with each other in the heat exchanger 13, heat is transferred from refrigerant to air-conditioning air to heat the air-conditioning air, the temperature of the air-conditioning air increases, and refrigerant releases heat to air-conditioning air to be cooled.

High-pressure liquid refrigerant liquefied in the heat exchanger 13 flows into the expansion valve 76 via the refrigerant lines 22a and 71. In the expansion valve 76, refrigerant in a supercooled liquid state is throttle-expanded, and the refrigerant decreases in temperature and pressure with the specific enthalpy of the refrigerant unchanged to become low-temperature and low-pressure wet steam in a gas-liquid mixing state.

Refrigerant of which the temperature is decreased in the expansion valve 76 flows to the heat exchanger 15 via the refrigerant lines 72 and 73. Refrigerant in a wet steam state flows into the tubes of the heat exchanger 15. When refrigerant flows through the tubes, the refrigerant absorbs heat of outside air via the fins as latent heat of vaporization to evaporate with a constant pressure. Refrigerant exchanges heat with outside air in the heat exchanger 15 to be heated, and the dryness of the refrigerant increases. Part of refrigerant receives latent heat in the heat exchanger 15 to vaporize, so the percentage of saturated steam contained in the refrigerant in a wet steam state increases.

In the gas-liquid separator 80, refrigerant in a gas-liquid two-phase state is separated into refrigerant steam in a saturated steam state and refrigerant liquid in a saturated liquid state. Refrigerant in a saturated liquid state flows out from the gas-liquid separator 80, flows to the cooling line 32 of the cooling portion 30 via the refrigerant line 33, and cools the EV device 31. In the cooling portion 30, heat is released to liquid refrigerant in a saturated liquid state, which is separated in the gas-liquid separator 80, to cool the EV device 31. Refrigerant is heated by exchanging heat with the EV device 31, and the dryness of the refrigerant increases. Refrigerant receives latent heat from the EV device 31 to partially vaporize into wet steam in a gas-liquid two-phase state, which mixedly contains saturated liquid and saturated steam at the outlet of the cooling portion 30.

Refrigerant in a wet steam state, flowing out from the cooling portion 30, flows into the heat exchanger 14 via the refrigerant lines 34 and 23a. Refrigerant in a wet steam state flows into the tubes of the heat exchanger 14. When refrigerant flows through the tubes, the refrigerant absorbs heat of outside, air via the fins as latent heat of vaporization to evaporate with a constant pressure, so the percentage of saturated steam contained in the refrigerant in a wet steam state increases.

In the heat exchanger 14, refrigerant may be heated until all the refrigerant becomes superheated steam, refrigerant may be heated until all the refrigerant becomes dry saturated steam or refrigerant may be in a wet saturated steam state at the outlet of the heat exchanger 14. When refrigerant flowing out from the heat exchanger 14 contains liquid refrigerant, refrigerant liquid is stored in the accumulator 85, and only gaseous refrigerant steam is introduced into the compressor 12. By so doing, refrigerant liquid is prevented from flowing into the compressor 12. FIG. 5 shows the state of refrigerant when refrigerant in a wet saturated steam state is separated into gas and liquid in the accumulator 85 and refrigerant in a dry saturated steam state flows out from the accumulator 85 to the compressor 12 via the refrigerant line 29. Refrigerant continuously repeats changes among the compressed state, the condensed state, the throttle-expanded state and the evaporated state in accordance with the above-described cycle.

The cooling system 1 according to the present embodiment includes the three-way valve 41 that switches flow of refrigerant in the vapor compression refrigeration cycle 10 between cooling operation and heating operation. During heating operation, refrigerant steam flowing inside the heat exchanger 13 condenses to release heat to air-conditioning air introduced so as to contact with the heat exchanger 13. The heat exchanger 13 uses high-temperature and high-pressure refrigerant adiabatically compressed in the compressor 12 to release heat of condensation, which is required at the time when refrigerant gas condenses into wet steam of refrigerant, to air-conditioning air flowing to the cabin of the vehicle to thereby heat the cabin of the vehicle. Air-conditioning air that receives heat from the heat exchanger 13 to increase its temperature flows into the cabin of the vehicle to thereby heat the cabin of the vehicle.

The cooling system 1 is able to appropriately adjust the temperature of air-conditioning air flowing to the cabin of the vehicle in the case of both cooling operation and heating operation. Therefore, it is possible to reduce the cost of the cooling system 1, and, in addition, it is possible to reduce the size of the cooling system 1. In addition, during heating operation, refrigerant flows to the cooling portion 30, and exchanges heat with the EV device 31 to cool the EV device 31. The cooling system 1 cools the EV device 31, which is the heat generating source mounted on the vehicle, by utilizing the vapor compression refrigeration cycle 10 for air-conditioning the cabin of the vehicle.

Thus, it is possible to provide the cooling system 1 that is able to appropriately cool the EV device 31 while maintaining excellent heating performance for heating the cabin of the vehicle and that ensures both heating performance for heating the vehicle cabin and cooling performance for cooling the EV device 31. In the cooling portion 30, the EV device 31 exchanges heat with low-temperature and low-pressure refrigerant after being throttle-expanded by the expansion valve 76, so it is possible to further improve cooling performance for cooling the EV device 31.

During heating operation, refrigerant absorbs heat from the EV device 31 in the cooling portion 30 to be heated, and absorbs heat from outside air in the heat exchanger 14 to be further heated. By heating refrigerant in both the cooling portion 30 and the heat exchanger 14, it is possible to effectively utilize heat waste from the EV device 31 for heating the cabin, so the coefficient of performance improves, and it is possible to reduce power consumption for adiabatically compressing refrigerant in the compressor 12 during heating operation.

The cooling system 1 includes the single gas-liquid separator 80. By using the single gas-liquid separator 80, during both cooling operation and heating operation, refrigerant in a gas-liquid two-phase state is separated into gas and liquid, and only refrigerant liquid that is liquid refrigerant separated in the gas-liquid separator 80 is supplied to the cooling portion 30 to cool the EV device 31. The liquid refrigerant is refrigerant in a just saturated liquid state. Therefore, by taking only liquid refrigerant from the gas-liquid separator 80 and flowing the liquid refrigerant to the cooling portion 30, the performance of the heat exchanger 15 arranged on the upstream side of the gas-liquid separator 80 may be fully utilized to cool the EV device 31, so it is possible to provide the cooling system 1 having improved cooling performance for cooling the EV device 31.

Refrigerant in a saturated liquid state at the outlet of the gas-liquid separator 80 is introduced into the cooling line 32 that cools the EV device 31 to thereby make it possible to minimum gaseous refrigerant within refrigerant that flows in the cooling system for cooling the EV device 31, including the cooling line 32. Therefore, it is possible to suppress an increase in pressure loss due to an increase in flow rate of refrigerant steam flowing in the cooling system for cooling the EV device 31, and the power consumption of the compressor 12 for flowing refrigerant may be reduced, so it is possible to avoid deterioration of the performance of the vapor compression refrigeration cycle 10.

When refrigerant liquid in a predetermined amount is stored in the gas-liquid separator 80, it is possible to maintain the flow rate of refrigerant flowing from the gas-liquid separator 80 to the cooling portion 30 at the time of switching between heating operation and cooling operation. Because the gas-liquid separator 80 has the function of storing liquid, it is possible to absorb fluctuations in refrigerant flow rate, that is, the flow rate of refrigerant flowing from the heat exchangers 14 and 15 to the gas-liquid separator 80 temporarily decreases at the time of switching between cooling operation and heating operation. Thus, it is possible to avoid a shortage of refrigerant supplied to the cooling portion 30 at the time of switching between heating operation and cooling operation, so it is possible to stabilize the cooling performance for cooling the EV device 31.

The refrigerant line 23 that forms a refrigerant path not passing through the cooling portion 30 and the refrigerant lines 33 and 34 and cooling line 32 that form a refrigerant path passing through the cooling portion 30 to cool the EV device 31 are provided in parallel with each other as the paths of refrigerant flowing from the gas-liquid separator 80 toward the heat exchanger 14. The cooling system for cooling the EV device 31, including the refrigerant lines 33 and 34, is connected in parallel with the refrigerant line 23. Therefore, only part of refrigerant flowing out from the gas-liquid separator 80 flows to the cooling portion 30. By adjusting the opening degree of the flow regulating valve 42 provided in the refrigerant line 23, the flow rate of refrigerant flowing from the gas-liquid separator 80 to the refrigerant line 23 and the flow rate of refrigerant flowing through the cooling portion 30 are appropriately adjusted. Through the flow rate adjustment, an amount of refrigerant required to cool the EV device 31 flows to the cooling portion 30, and the EV device 31 is appropriately cooled.

The path of refrigerant that flows from the heat exchanger 15 to the heat exchanger 14 without passing through the cooling portion 30 and the path of refrigerant that flows from the heat exchanger 15 to the heat exchanger 14 via the cooling portion 30 are provided in parallel with each other, and only part of refrigerant is caused to flow to the refrigerant lines 33 and 34. By so doing, it is possible to reduce the pressure loss at the time when refrigerant flows through the cooling system for cooling the EV device 31. Not the entire refrigerant flows to the cooling portion 30. Therefore, it is possible to reduce the pressure loss associated with flow of refrigerant via the cooling portion 30, and, accordingly, it is possible to reduce power consumption required to operate the compressor 12 for circulating refrigerant.

As described above, during normal heat generation in which the EV device 31 generates the amount of heat smaller than the maximum heat generation amount, it may be understood that the heat exchangers 14 and 15 each apparently increase in size and the temperature efficiency φc of each of the heat exchangers 14 and 15 becomes higher. An air-side cooling performance Qea in each of the heat exchangers 14 and 15 is directly proportional to the temperature efficiency φc of the heat exchanger, an air specific heat Ca, an air volume by weight Gea and a difference (Tea−Ter) obtained by subtracting a refrigerant temperature Ter from an intake air temperature Tea. The required cooling performance Qea is unchanged, and the air specific heat Ca, the air volume by weight Gea and the intake air temperature Tea are determined in accordance with an outside air temperature and a vehicle speed, so the refrigerant temperature Ter increases by the amount of increase in the temperature efficiency φc. A decrease in the refrigerant temperature Ter in the heat exchangers 14 and 15 means an increase in the pressure of refrigerant flowing through the heat exchangers 14 and 15.

The pressure of refrigerant in the heat exchangers 14 and 15 increases, and the low pressure of the vapor compression refrigeration cycle 10 increases. As a result, the pressure of refrigerant at the inlet of the compressor 12 increases. Therefore, it is possible to reduce power for adiabatically compressing refrigerant in the compressor 12 in order to obtain a predetermined refrigerant pressure at the outlet of the compressor 12, so it is possible to achieve further power saving. Thus, it is possible to improve the fuel consumption of the vehicle. Particularly, in an electric vehicle, it is possible to directly improve electric power consumption through power saving.

### Third Operation Mode

FIG. 6 is a schematic view that shows the operation of the cooling system 1 in the third operation mode. As shown in FIG. 2A, FIG. 2B and FIG. 6, the third operation mode is an operation mode in which heating performance is slightly decreased but it is possible to dehumidify the vehicle cabin during operation of the air conditioner for heating the cabin of the vehicle.

In the third operation mode, refrigerant is required to flow through a path that includes the heat exchanger 13 in order to heat the vehicle cabin, so the compressor 12 is in an operating state. The flow regulating valve 42 adjusts the flow rate of refrigerant flowing through the cooling portion 30, and the valve opening degree of the flow regulating valve 42 is adjusted such that a sufficient amount of refrigerant flows to the cooling portion 30 in order to cool the EV device 31. The flow regulating valve 43 is fully opened so as to minimize the pressure loss of refrigerant flowing through the refrigerant line 24. The open/close state of the three-way valve 41 is switched such that the refrigerant line 22a and the refrigerant line 71 are in fluid communication with each other and the refrigerant line 22b is not in fluid communication with both the refrigerant lines 22a and 71.

The on-off valve 37 is opened, and the refrigerant line 34 is set in a fluid communication state. The on-off valve 38 is closed, and the refrigerant line 35 is interrupted. The on-off valve 52 is closed, and the communication line 51 is interrupted. The open/close states of the selector valve 36 and on-off valve 52 are switched such that refrigerant flowing out from the cooling portion 30 flows to the refrigerant line 34 and does not flow to the refrigerant line 35 and the communication line 51. The on-off valves 64, 77 and 78 each are opened, and the refrigerant lines 61, 73 and 74 are set in a fluid communication state. The on-off valve 44 is closed, and the refrigerant line 25 is interrupted.

Refrigerant passes through a refrigerant circulation path that is formed by sequentially connecting the compressor 12, the heat exchanger 13, the expansion valve 76 and the heat exchangers 15 and 14 by the refrigerant lines 21, 22a, 71, 72, 73, 25, 24, 23, 22b, 61 and 29 to circulate in the vapor compression refrigeration cycle 10. Refrigerant also passes through a refrigerant circulation path that is formed by sequentially connecting the compressor 12, the heat exchanger 13, the expansion valve 76 and the heat exchanger 18 by the refrigerant lines 21, 22a, 71, 72, 74, and 26 to 29 to circulate in the vapor compression refrigeration cycle 10. Refrigerant passing through the expansion valve 76 flows to the heat exchangers 15 and 14 and the heat exchanger 18 in parallel.

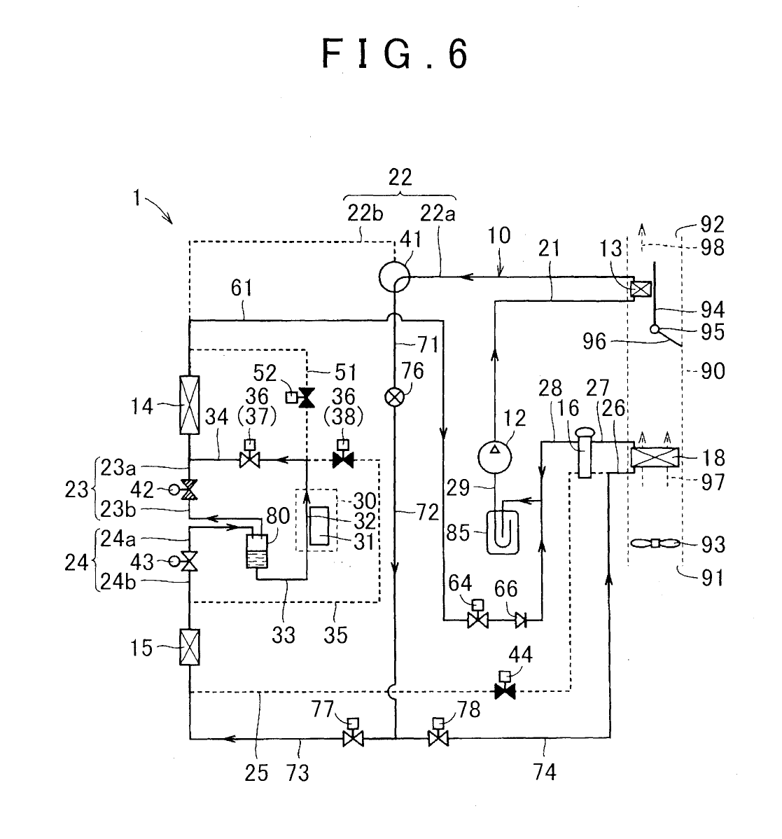

FIG. 7 is a Mollier chart that shows the state of refrigerant in the vapor compression refrigeration cycle 10 in the third operation mode. In FIG. 7, the abscissa axis represents the specific enthalpy of refrigerant, and the ordinate axis represents the absolute pressure of refrigerant. The unit of the specific enthalpy is kJ/kg, and the unit of the absolute pressure is MPa. The curve in the chart is the saturation vapor line and saturation liquid line of refrigerant.

FIG. 7 shows the thermodynamic state of refrigerant at points in the vapor compression refrigeration cycle 10 when refrigerant is adiabatically compressed in the compressor 12, is condensed in the heat exchanger 13, is throttle-expanded by the expansion valve 76 and evaporates in the heat exchanger 18 in addition to the thermodynamic state of refrigerant that flows into the cooling portion 30 to cool the EV device 31 as shown in FIG. 5. The state of refrigerant that cools the EV device 31 and the state of refrigerant that reaches from the compressor 12 to the expansion valve 76 are the same as those of the second operation mode, so the description thereof is not repeated. Hereinafter, the state of refrigerant that flows from the expansion valve 76 toward the heat exchanger 18, which is characteristic to the third operation mode, will be described.

Refrigerant that is decompressed in the expansion valve 76 and is decreased in temperature flows to the refrigerant line 72. Refrigerant branches off from the refrigerant line 72 to the refrigerant lines 73 and 74, and part of refrigerant flows to the heat exchanger 18 via the refrigerant lines 74 and 26. Part of refrigerant that circulates in the vapor compression refrigeration cycle 10 branches off and flows to the heat exchanger 18, and refrigerant in a wet steam state, which is lower in temperature than a dew point temperature of air-conditioning air, flows into the tubes of the heat exchanger 18. The heat exchanger 18 absorbs heat of air-conditioning air introduced so as to contact with the heat exchanger 18 by vaporization of atomized refrigerant flowing inside the heat exchanger 18 to thereby decrease the temperature of the air-conditioning air. When refrigerant flows through the tubes of the heat exchanger 18, the refrigerant absorbs heat of air-conditioning air via the fins as latent heat of vaporization to be heated and evaporate with a constant pressure. Thus, the dryness of refrigerant increases.

Refrigerant is in a wet saturated steam state at the outlet of the heat exchanger 18. After that, refrigerant flows to the accumulator 85. Refrigerant liquid is stored in the accumulator 85, and only gaseous refrigerant steam is introduced into the compressor 12. By so doing, refrigerant liquid is prevented from flowing into the compressor 12.

In the thus described third operation mode, air-conditioning air that flows through the duct 90 is cooled by releasing heat to refrigerant in the heat exchanger 18. When the temperature of air-conditioning air is decreased to below the dew point temperature, water vapor contained in air-conditioning air condensates, and the amount of water vapor contained in air-conditioning air reduces. After that, air-conditioning air receives heat from refrigerant in the heat exchanger 13 to be heated. Air-conditioning air after being cooled in the heat exchanger 18 is heated in the heat exchanger 13. By so doing, the humidity of air-conditioning air decreases. In this way, dried air-conditioning air is introduced into the cabin of the vehicle, so it is possible to dehumidify the vehicle cabin in addition to heating operation.

In the third operation mode, the temperature of air-conditioning air is once decreased in the heat exchanger 18, so heating performance decreases as compared with the second operation mode, but it is advantageously possible to dehumidify the vehicle cabin. In the case of the cooling system 1 that is mounted on the vehicle, a dehumidifying function for, for example, removing fogging of a vehicle window is indispensable. According to the present embodiment, it is possible to implement the cooling system 1 that includes the dehumidifying function in addition to the heating and cooling function and that is able to further appropriately cool the EV device 31 with a simple configuration.

### Fourth Operation Mode

FIG. 8 is a schematic view that shows the operation of the cooling system 1 in the fourth operation mode. As shown in FIG. 2A, FIG. 2B and FIG. 8, the fourth operation mode is an operation mode in which dehumidifying performance for dehumidifying the vehicle cabin is further increased during operation of the air conditioner for heating the cabin of the vehicle.

In the fourth operation mode, refrigerant is required to flow through a path that includes the heat exchanger 13 in order to heat the vehicle cabin, so the compressor 12 is in an operating state. The flow regulating valve 42 is fully opened so as to minimize the pressure loss of refrigerant flowing through the refrigerant line 23. The flow regulating valve 43 is fully closed, and the refrigerant line 24 is interrupted. The open/close state of the three-way valve 41 is switched such that the refrigerant line 22a and the refrigerant line 71 are in fluid communication with each other and the refrigerant line 22b is, not in fluid communication with both the refrigerant lines 22a and 71.

The on-off valves 37 and 38 are closed, and the refrigerant lines 34 and 35 are interrupted. The on-off valve 52 is opened, and the communication line 51 is set in a fluid communication state. The open/close states of the selector valve 36 and on-off valve 52 are switched such that refrigerant flowing out from the cooling portion 30 flows to the communication line 51 and does not flow to the refrigerant line 34 and the refrigerant line 35. The on-off valve 78 is opened, and the refrigerant line 74 is set in a fluid communication state. The on-off valves 44, 64 and 77 each are closed, and the refrigerant lines 25, 61 and 73 are interrupted.

Refrigerant passes through a refrigerant circulation path that is formed by sequentially connecting the compressor 12, the heat exchanger 13, the expansion valve 76 and the heat exchanger 18 by the refrigerant lines 21, 22a, 71, 72, 74, and 26 to 29 to circulate in the vapor compression refrigeration cycle 10. Refrigerant also passes through a refrigerant circulation path that is formed by connecting the cooling portion 30 to the heat exchanger 14 by the refrigerant line 23, the gas-liquid separator 80, the refrigerant line 33, the communication line 51 and the refrigerant line 22b.

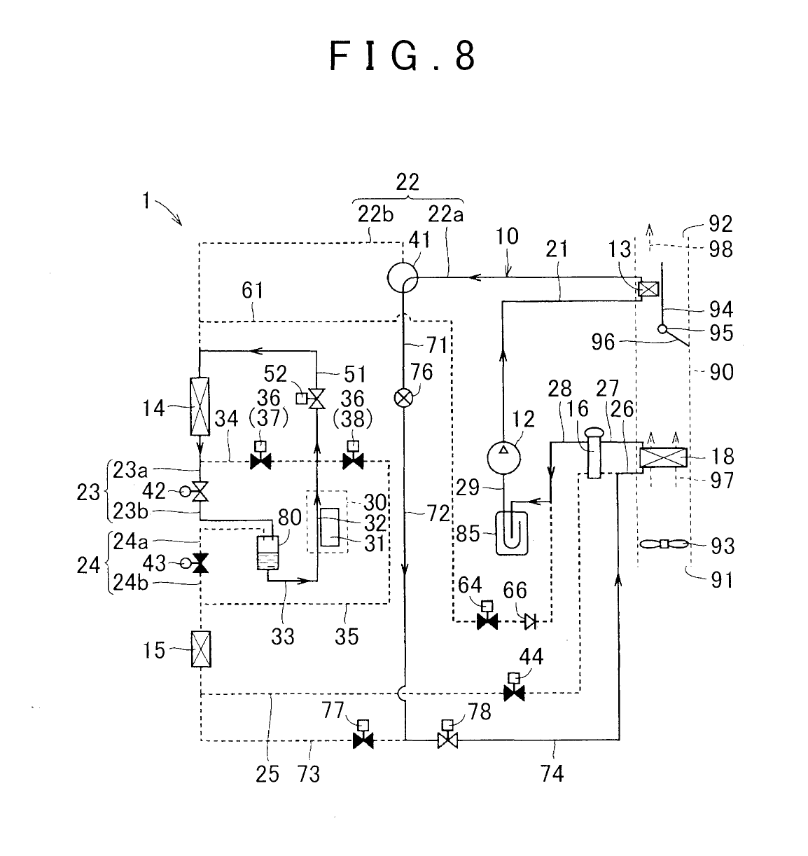

FIG. 9 is a schematic view that shows the configuration of part of the cooling system 1 shown in FIG. 8. With the above-described settings of the open/close states of the three-way valve 41, the flow regulating valves 42 and 43 and the on-off valves 37, 38, 52 and 64, flow of refrigerant that circulates between the cooling portion 30 and the heat exchanger 14 occurs. That is, a closed annular path that is routed from the heat exchanger 14 to the cooling portion 30 via the refrigerant line 23, the gas-liquid separator 80 and the refrigerant line 33 sequentially, and further passes through the communication line 51 and the refrigerant line 22 sequentially and returns to the heat exchanger 14. It is possible to circulate refrigerant between the heat exchanger 14 and the cooling portion 30 via the annular path.

When refrigerant cools the EV device 31, the refrigerant receives latent heat of vaporization from the EV device 31 to evaporate. Refrigerant steam vaporized by exchanging heat with the EV device 31 flows to the heat exchanger 14 via the communication line 51 and the refrigerant line 22 sequentially. In the heat exchanger 14, refrigerant steam is cooled to condense by running wind of the vehicle or draft from a cooling fan. Refrigerant liquid liquefied in the heat exchanger 14 flows to the gas-liquid separator 80 via the refrigerant line 23. Liquid refrigerant separated in the gas-liquid separator 80 returns to the cooling portion 30 via the refrigerant line 33.

In this way, a heat pipe in which the EV device 31 serves as a heating portion and the heat exchanger 14 serves as a cooling portion is formed by the annular path that passes through the cooling portion 30 and the heat exchanger 14. Thus, it is possible to supply refrigerant to the cooling portion 30 without the necessity of the power of the compressor 12, so it is possible to reliably cool the EV device 31.

FIG. 9 shows a ground 100. The cooling portion 30 for cooling the EV device 31 is arranged below the heat exchanger 14 in the vertical direction perpendicular to the ground 100. In the annular path that circulates refrigerant between the heat exchanger 14 and the cooling portion 30, the cooling portion 30 is arranged below, and the heat exchanger 14 is arranged above. The heat exchanger 14 is arranged at the level higher than the cooling portion 30.

In this case, refrigerant steam heated and vaporized in the cooling portion 30 goes up in the annular path, reaches the heat exchanger 14, is cooled in the heat exchanger 14, condenses into liquid refrigerant, goes down in the annular path by the action of gravity and returns to the cooling portion 30. That is, a thermo-siphon heat pipe is formed of the cooling portion 30, the heat exchanger 14 and the refrigerant paths that connect them. During heat pipe operation, the potential head of refrigerant liquefied in the heat exchanger 14 influences the circulation amount of refrigerant, so, by arranging the heat exchanger 14 at a level higher than the cooling portion 30, it is possible to improve the heat-transfer efficiency from the EV device 31 to the heat exchanger 14, and it is possible to further improve cooling performance for cooling the EV device 31. Thus, even when the vapor compression refrigeration cycle 10 is stopped, it is possible to further efficiently cool the EV device 31 without adding power.

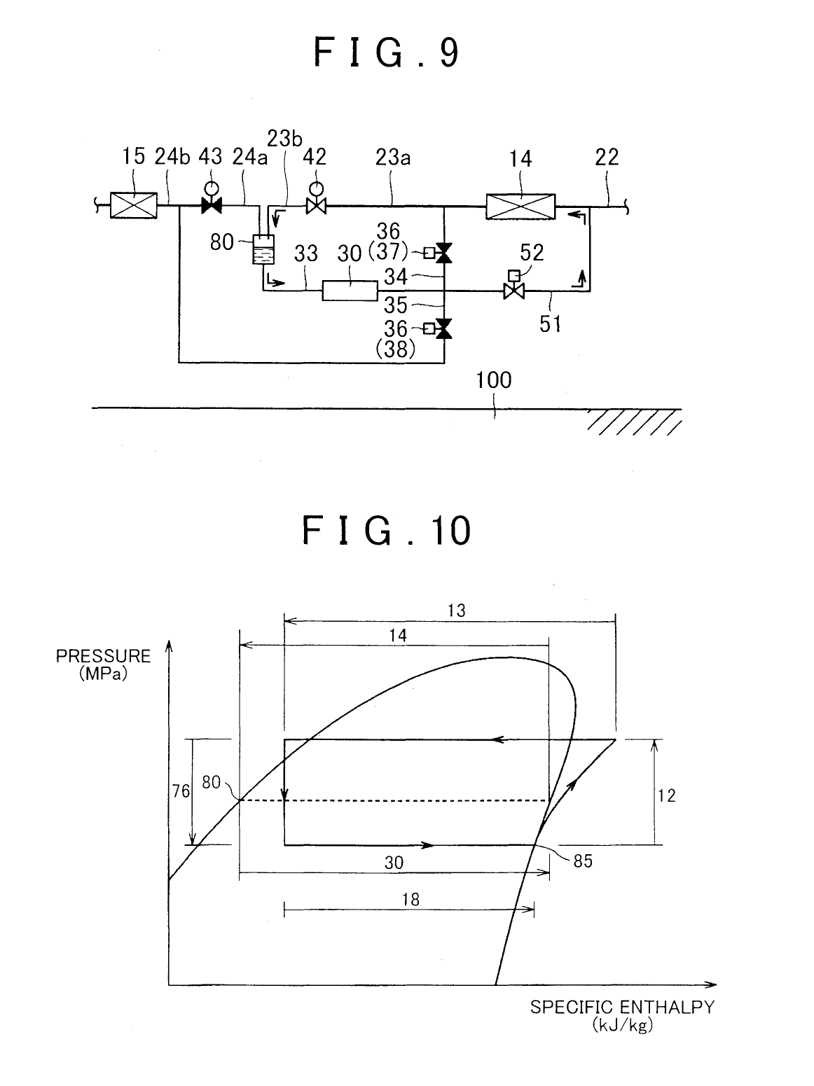

FIG. 10 is a Mollier chart that shows the state of refrigerant in the vapor compression refrigeration cycle 10 in the fourth operation mode. In FIG. 10, the abscissa axis represents the specific enthalpy of refrigerant, and the ordinate axis represents the absolute pressure of refrigerant. The unit of the specific enthalpy is kJ/kg, and the unit of the absolute pressure is MPa. The curve in the chart is the saturation vapor line and saturation liquid line of refrigerant.

FIG. 10 shows the thermodynamic state of refrigerant that flows from the expansion valve 76 toward the heat exchanger 18 by the solid line, which is also shown in FIG. 7, and further shows the thermodynamic state of refrigerant that circulates in a closed loop that is formed of a refrigerant path that connects the heat exchanger 14, the gas-liquid separator 80 and the cooling portion 30 by the dotted line. The state of refrigerant that heats and dehumidifies air-conditioning air is the same as that of the third operation mode, so the description thereof is not repeated. Hereinafter, the state of refrigerant that circulates between the heat exchanger 14 and the cooling portion 30, which is characteristic to the fourth operation mode, will be described.

Refrigerant flowing into the heat exchanger 14 releases heat to surroundings to be cooled at the time of flowing through the tubes of the heat exchanger 14 due to running wind of the vehicle or draft from the cooling fan to thereby condense (liquefy). Through heat exchange with outside air in the heat exchanger 14, the temperature of refrigerant decreases, and refrigerant liquefies. In the heat exchanger 14, refrigerant releases latent heat of condensation to gradually liquefy with a constant pressure into wet steam in a gas-liquid mixing state. Refrigerant in a gas-liquid two-phase state flows to the gas-liquid separator 80 via the refrigerant line 23, and is separated into refrigerant steam in a saturated steam state and refrigerant liquid in a saturated liquid state in the gas-liquid separator 80.

Refrigerant in a saturated liquid state flows out from the gas-liquid separator 80, flows to the cooling line 32 of the cooling portion 30 via the refrigerant line 33, and cools the EV device 31. In the cooling portion 30, heat is released to liquid refrigerant in a saturated liquid state, which is condensed in the heat exchanger 14 and is separated in the gas-liquid separator 80, to thereby cool the EV device 31. Refrigerant is heated by exchanging heat with the EV device 31, gradually evaporates with a constant pressure, and the dryness of the refrigerant increases. Typically, in the cooling portion 30, heat is exchanged between refrigerant and the EV device 31 until all the refrigerant becomes dry saturated steam. Refrigerant of which part or all is vaporized through heat exchange with the EV device 31 flows out from the cooling portion 30 and returns to the heat exchanger 14 via the communication line 51 and the refrigerant line 22 sequentially.

In the third operation mode shown in FIG. 6, only part of low-temperature and low-pressure refrigerant decompressed by the expansion valve 76 flows to the heat exchanger 18. In contrast to this, in the fourth operation mode, all the low-temperature and low-pressure refrigerant decompressed by the expansion valve 76 flows to the heat exchanger 18. Because of an increase in the amount of refrigerant that flows to the heat exchanger 18, heating performance further decreases as compared with the third operation mode; however, it is possible to further cool air-conditioning air in the heat exchanger 18, so dehumidifying performance for dehumidifying air-conditioning air improves. By operating the cooling system 1 in the fourth operation mode, it is possible to further dehumidify air inside the vehicle cabin, so it is possible to quickly and reliably carry out dehumidification.

Refrigerant that is driven by the compressor 12 does not flow to the cooling portion 30; however, a loop heat pipe that uses the heat exchanger 14 as a condenser and uses the cooling portion 30 as an evaporator operates to reliably cool the EV device 31. The power of the compressor 12 is not required to cool the EV device 31, and it is possible to cool the EV device 31 with no power.

Thus, it is possible to implement the cooling system 1 that includes the further excellent dehumidifying function and that is able to further appropriately cool the EV device 31 with a simple configuration. It is possible to cool the EV device 31 with no power, so it is possible to further improve power saving and comfort by reducing the power consumption of the compressor 12.

### Fifth Operation Mode

FIG. 11 is a schematic view that shows the operation of the cooling system 1 in the fifth operation mode. As shown in FIG. 2A, FIG. 2B and FIG. 11, the fifth operation mode is an operation mode in which the EV device 31 is cooled with no power during a stop of the air conditioner for heating the cabin of the vehicle.

In the fifth operation mode, the air conditioner in the vehicle cabin is stopped, and it is not required to heat or cool air-conditioning air, so the compressor 12 is in a stopped state. The flow regulating valve 42 is fully opened so as to minimize the pressure loss of refrigerant flowing through the refrigerant line 23. The flow regulating valve 43 is fully closed, and the refrigerant line 24 is interrupted. The open/close state of the three-way valve 41 is switched such that the refrigerant line 22a and the refrigerant line 71 are in fluid communication with each other and the refrigerant line 22b is not in fluid communication with both the refrigerant lines 22a and 71.

The on-off valves 37 and 38 are closed, and the refrigerant lines 34 and 35 are interrupted. The on-off valve 52 is opened, and the communication line 51 is set in a fluid communication state. The open/close states of the selector valve 36 and on-off valve 52 are switched such that refrigerant flowing out from the cooling portion 30 flows to the communication line 51 and does not flow to the refrigerant line 34 and the refrigerant line 35. The on-off valve 64 is closed, and the refrigerant line 61 is interrupted. The open/close states of the other on-off valves 44, 77 and 78 are arbitrarily selected.

Refrigerant passes through a refrigerant circulation path that is formed by connecting the cooling portion 30 to the heat exchanger 14 by the refrigerant line 23, the gas-liquid separator 80, the refrigerant line 33, the communication line 51 and the refrigerant line 22b.

As in the case of the fourth operation mode, a heat pipe in which the EV device 31 serves as a heating portion and the heat exchanger 14 serves as a cooling portion is formed by the annular path that passes through the cooling portion 30 and the heat exchanger 14. It is possible to circulate refrigerant between the heat exchanger 14 and the cooling portion 30 via the annular path without operating the compressor 12.

Therefore, even when the vapor compression refrigeration cycle 10 is stopped, that is, even when cooling for the vehicle is stopped, it is possible to reliably cool the EV device 31 without the necessity of a start-up of the compressor 12. It is possible to cool the EV device 31 with no power, and the compressor 12 is not required to constantly operate in order to cool the EV device 31. By so doing, it is possible to improve further power saving and comfort by reducing the power consumption of the compressor 12, and, in addition, it is possible to improve the reliability of the compressor 12 because the life of the compressor 12 is extended.

During operation of the cooling system 1 in the fourth or fifth operation mode, when it is not possible to sufficiently ensure the potential head of refrigerant because of a shortage of the amount of refrigerant inside the closed loop refrigerant path, the compressor 12 is operated in a forced operation so as to operate in only a short period of time in a state where the three-way valve 41 is switched so as to provide fluid communication between the refrigerant line 22a and the refrigerant line 22b. Through the forced operation, refrigerant accumulating in the heat exchangers 13 and 18 is drawn up and is supplied to the closed loop path, the amount of refrigerant in the closed loop is increased, thus ensuring the amount of refrigerant in the heat pipe. As a result, it is possible to ensure the potential head of refrigerant at which it is possible to ensure cooling performance required to cool the EV device 31, so it is possible to increase the amount of heat exchanged in the heat pipe, and it is possible to avoid a situation that cooling the EV device 31 is insufficient due to a shortage of the amount of refrigerant.

Note that, in the above-described embodiment, the cooling system 1 that cools an electrical device mounted on the vehicle is described using the EV device 31 as an example. The electrical device is not limited to the illustrated electrical devices, such as an inverter and a motor generator. The electrical device may be any electrical device as long as it generates heat when it is operated. In the case where there are a plurality of electrical devices to be cooled, the plurality of electrical devices desirably have a common cooling target temperature range. The cooling target temperature range is an appropriate temperature range within which the electrical device is operated.

Furthermore, the heat generating source cooled by the cooling system 1 according to the embodiment of the invention is not limited to the electrical device mounted on the vehicle; instead, it may be any device that generates heat or may be a heat generating portion of any device.

The embodiment according to the invention is described above; however, the embodiment described above should be regarded as only illustrative in every respect and not restrictive. The scope of the invention is indicated not by the above description but by the appended claims, and is intended to include all modifications within the meaning and scope equivalent to the scope of the appended claims.

The cooling system according to the invention may be particularly advantageously applied to cooling of an electrical device, such as a motor generator and an inverter, using a vapor compression refrigeration cycle for cooling a cabin, in a vehicle, such as a hybrid vehicle, a fuel-cell vehicle and an electric vehicle, equipped with the electrical device.

1. A cooling system cooling a heat generating source, comprising:
a compressor configured to compress refrigerant circulating in the cooling system; a first heat exchanger configured to exchange heat between the refrigerant and outside air;
a second heat exchanger configured to exchange heat between the refrigerant and outside air;
a first decompressor configured to decompress the refrigerant;
a third heat exchanger configured to exchange heat between the refrigerant and air-conditioning air;
a reservoir configured to store the refrigerant in a liquid phase, the refrigerant being condensed in the first heat exchanger or the second heat exchanger;
a cooling portion configured to cool the heat generating source using the refrigerant in a liquid phase;
a first selector valve configured to switch between flow of the refrigerant from the first heat exchanger toward the cooling portion via the reservoir and flow of the refrigerant from the second heat exchanger toward the cooling portion via the reservoir; a first line providing fluid communication between the first heat exchanger and the reservoir;
a second line providing fluid communication between the second heat exchanger and the reservoir;
a third line, the refrigerant in a liquid phase flowing from the reservoir toward the cooling portion through the third line;
a first flow regulating valve provided in the first line, the first flow regulating valve being configured to adjust a flow rate of the refrigerant flowing through the cooling portion;
a second flow regulating valve provided in the second line, the second flow regulating valve being configured to adjust the flow rate of the refrigerant flowing through the cooling portion;
a fourth line providing fluid communication between an outlet side of the cooling portion and the first line between the first heat exchanger and the first flow regulating valve;
a fifth line providing fluid communication between the outlet side of the cooling portion and the second line between the second heat exchanger and the second flow regulating valve; and
a second selector valve configured to switch between flow of the refrigerant from the cooling portion toward the first heat exchanger via the fourth line and flow of the refrigerant from the cooling portion toward the second heat exchanger via the fifth line.

2. The cooling system according to claim 1, further comprising:
a sixth line constituting a path of the refrigerant flowing into or flowing out from the first heat exchanger together with the first line;
a communication line providing fluid communication between the outlet side of the cooling portion and the sixth line; and
an on-off valve configured to open or close the communication line.

3. The cooling system according to claim 2, wherein
the heat generating source is arranged below the first heat exchanger.

4. The cooling system according claim 1, wherein the first heat exchanger has a higher heat radiation performance for releasing heat from the refrigerant than the second heat exchanger.

5. The cooling system according to claim 1, further comprising:
an interior condenser arranged on a downstream side of flow of the air-conditioning air with respect to the third heat exchanger, the interior condenser being configured to transfer heat from the refrigerant compressed in the compressor to the air-conditioning air to heat the air-conditioning air.

6. The cooling system according to claim 1, further comprising:
a second decompressor provided in a path of the refrigerant flowing from the compressor to the second heat exchanger via the first selector valve, the second decompressor being configured to decompress the refrigerant; and
a branching line configured to branch part of the refrigerant decompressed in the second decompressor, the branching line flowing the part of the refrigerant to the third heat exchanger.
